(19) United States
(12) Patent Application Publication
(10) Pub. No.: US 2026/0029512 A1
(43) Pub. Date: Jan. 29, 2026

(54) SYSTEMS AND METHODS FOR DETERMINISTIC RELATIVE VELOCITY VECTORS

(71) Applicant: Psionic Inc, Hampton Way, VA (US)

(72) Inventors: Stephen Parker Sandford, Yorktown, VA (US); Diego Fernando Pierrottet, Poquoson, VA (US)

(73) Assignee: Psionic Inc, Hampton Way, VA (US)

(21) Appl. No.: 19/346,436

(22) Filed: Sep. 30, 2025

Related U.S. Application Data
(63) Continuation of application No. 16/501,526, filed on Apr. 23, 2019.
Application No. 16/501,526 is a continuation-in-part of application No. 15/932,639, filed on Mar. 28, 2018, now Pat. No. 10,935,670.

(51) Int. Cl. G01S 7/48; G01S 7/481; G01S 17/93; G06F 17/11

(52) U.S. Cl. CPC G01S 7/4808; G01S 7/4804; G01S 7/4818; G01S 17/93; G06F 17/11

(57) ABSTRACT

Methods and apparatus for providing self-contained guidance, navigation, and control (GN&C) functions for a vehicle moving through an environment on or near the ground, in the air or in space without externally provided information are disclosed. More particularly, one embodiment of the present invention includes a Heading Sensor (36), an Absolute Location Sensor (38), a timer (40), a Range Doppler Processor (42), a Navigation Reference Sensor (44), an Area Range and a Velocity Sensor (46) which provide enhanced navigation information about a universal reference frame (22) and one or more targets (20).

### CROSS-REFERENCE TO RELATED PATENT APPLICATIONS

This patent application is a continuation of, and claims priority to and the benefit of U.S. patent application Ser. No. 16/501,526, titled “NAVIGATION SYSTEMS FOR GPS DENIED ENVIROMENTS,” and filed Apr. 23, 2019, which is a continuation-in-part of U.S. patent application Ser. No. 15/932,639, titled, “NAVIGATION SYSTEMS FOR GPS DENIED ENVIROMENTS,” and filed Mar. 28, 2018, the contents of all of which are hereby incorporated herein by reference in its entirety for all purposes.

### FIELD OF THE INVENTION

One embodiment of the present invention relates to methods and apparatus for obtaining position, orientation, location, altitude, velocity, acceleration or other geodetic, calibration or measurement information useful for navigation in GPS denied environments. More particularly, one embodiment of the invention pertains to the illumination of one or more targets or other objects with LIDAR emissions, receiving one or more reflections from targets or other objects using customized sensors, and then processing the reflections with purposefully designed software to produce information that is presented on a visual display for a user or used by an autonomous controller.

### BACKGROUND

Navigation is a process that ideally begins with an absolute knowledge of one's location, \vec{r}₀. The goal is to reach a destination located somewhere else, \vec{r}. Once movement begins it becomes critical to know how fast one is moving (v=speed), in what direction (heading), and how long (t=time elapsed) one moves at that speed in that direction. If these are known without error then the equation, \vec{v}t+\vec{r₀}=\vec{r}, gives the current location at time t. Errors in speed, timing or direction will introduce uncertainty in the new location. Changes in speed or heading require one to also incorporate accelerations so the equation becomes

$$\frac{1}{2} \vec{a} {t}^{2} + \vec{{r}_{0}} = \vec{r}$$

For aerial vehicles there are three angles of orientation (pitch, roll, and yaw) and three position coordinates (x, y, and height above the ground) that can change with time. These six degrees of freedom (6-DOF) means there are six variables that need to be measured in order to know where one is at any particular time. For ground vehicles that travel in the plane of a surface then there are only two position coordinates (x and y) and one angle (yaw) that need to be measured to know where one is at any particular time. This is a 3 degree of freedom (3-DOF) problem. The same general principles of navigation apply and low-error measurements of speed relative to the ground combined with velocity relative to environmental hazards provides a powerful new navigation capability.

The Global Positioning System (GPS) comprises a set of satellites in orbit which transmit signals toward the surface of the Earth. A person on the ground may use a signal received by a GPS radio to determine his or her location or altitude.

According to Wikipedia:

“The Global Positioning System (GPS), originally Navstar GPS, is a space-based radionavigation system owned by the United States government and operated by the United States Air Force.”

“It is a global navigation satellite system that provides geolocation and time information to a GPS receiver anywhere on or near the Earth where there is an unobstructed line of sight to four or more GPS satellites.”

“The GPS does not require the user to transmit any data, and it operates independently of any telephonic or internet reception, though these technologies can enhance the usefulness of the GPS positioning information. The GPS provides critical positioning capabilities to military, civil, and commercial users around the world. The United States government created the system, maintains it, and makes it freely accessible to anyone with a GPS receiver.”

“The GPS project was launched by the U.S. Department of Defense in 1973 for use by the United States military and became fully operational in 1995. It was allowed for civilian use in the 1980s.”

In some situations and conditions, the GPS is unavailable. A location, area or region which does not offer location service via the GPS is called a “GPS denied environment.” This environment or condition can occur or be caused by geographical or topological constraints, or by the deliberate action of persons who seek to disable the GPS service. For example, an enemy on a battlefield may seek to jam or to interfere with the GPS service to deny its use to an adversary.

In this situation, a person, a vehicle or some other user needs some other apparatus and/or hardware to accurately determine location and/or altitude without the benefit of GPS.

The development of a system that enables a user or an automated controller to determine position, orientation, location, altitude, velocity, acceleration or other geodetic, calibration or measurement information would be a major technological advance, and would satisfy long-felt needs in the satellite and telecommunications industries.

### SUMMARY OF THE INVENTION

One embodiment of the present invention includes methods and apparatus for providing self-contained guidance, navigation, and control (GN&C) functions for a vehicle moving through an environment on the ground, in the air or in space without externally provided information. In some battlefield or other hostile situations, an enemy or an antagonist may suppress, spoof or interfere with external navigation systems like GPS. The system provides situational awareness information suitable for artificial intelligence decision making, and avoidance of stationary or mobile hazards and hazard-relative navigation. One embodiment of the present invention is specifically designed to supply navigation information in a GPS denied environment. Alternative embodiments use the hardware and software described in the Detailed Description to provide enhanced navigation information to a wide variety of vehicles. The present invention may configured to supply navigation information when combined with control systems aboard commercial or civilian aircraft, including passenger and cargo planes, UAVs and drones; as well on as cars and trucks on conventional roads and highways.

The present invention detects vehicle velocity vector and range with respect to a reference point, plane or object, and vehicle relative velocity and range to and of other vehicles and/or objects in its environment to provide vehicle state data required for navigation and situational awareness for guidance and control functions. Combining sensor information from these two velocity sensors and range sensors and other onboard sensors offers capability not possible with current onboard systems. Navigation without GPS signals and without significant systematic errors offers new capability for GPS denied vehicles.

The present invention can largely eliminate the systematic error due to the linear accelerometers used for navigation. By combining a good clock and a heading sensor like a compass, a gyroscope, and/or a terrain matching system with Doppler LIDAR (Light, Detection and Ranging) based sensors, the present invention allows stealthy, self-reliant, accurate navigation over long distances which is not economically possible with current technology.

Knowledge of initial location, as well as heading and elapsed time, may be obtained by a number of methods. The present invention offers highly accurate speed measurements that do not degrade over time due to accumulated error. This comes about because the present invention, unlike previous systems, measures speed directly rather than position measurements that are differentiated or acceleration measurements that are integrated to obtain velocity.

The present invention enables accurate, long-term navigation, and sense and avoid decisions using only information obtained from onboard sensors. By combining sensors operating in different modes, critical navigational state parameters are measured continuously without significant systematic errors that allows a vehicle whose initial state is known to execute guidance, navigation, and control (GN&C) functions to reach its desired destination safely.

An appreciation of the other aims and objectives of the present invention, and a more complete and comprehensive understanding of this invention, may be obtained by studying the following description of a preferred embodiment, and by referring to the accompanying drawings.

### BRIEF DESCRIPTION OF THE DRAWINGS

FIG. 1 is a generalized view of one embodiment of a System for Navigation in a GPS Denied Environment.

FIGS. 2 & 3 are schematic illustrations of generalized sensor system reference frames, including a universal reference frame, a vehicle reference frame, and a target reference frame.

FIG. 4 presents a schematic view of the elements of one embodiment of the present invention.

FIG. 5 is a schematic block diagram of one embodiment of a Navigation Reference Sensor.

FIG. 6 is a schematic block diagram of one embodiment of an Area Range & Velocity Sensor.

FIG. 7 is a schematic block diagram of one embodiment of a Range Doppler Processor.

FIG. 8 is a flow chart that reveals the method steps that are implemented in one embodiment of a Location Processor.

FIG. 9 portrays instruments in a helicopter that supply navigation information and navigation attributes employed in one embodiment of the present invention.

FIG. 10 depicts navigation attributes that are employed in one embodiment of the present invention.

FIG. 11 furnishes a flow chart of method steps pertaining to Coherent LIDAR Operation which are implemented in one embodiment of the present invention.

FIG. 12 provides a flow chart of method steps pertaining to an algorithm for determining the location of a vehicle which are implemented in one embodiment of the present invention.

FIG. 13 offers a schematic view of a ground vehicle which utilizes an alternative embodiment of the invention to find an optimized path that avoids an accident.

FIG. 14 supplies a schematic view of a ground vehicle which employs an alternative embodiment of the invention to recover after loss of control.

FIG. 15 depicts an In-Vehicle Interface Display for a ground vehicle that may be used in an alternative embodiment of the invention.

FIG. 16 depicts another view of an In-Vehicle Interface Display for a ground vehicle that may be used in an alternative embodiment of the invention.

FIG. 17 is a schematic view of an Intelligent Transportation System that includes Area Situational Awareness.

FIG. 18 is a schematic view of an Intelligent Transportation System that includes Area Situational Awareness.

FIG. 19 provides yet another schematic view of which illustrates Situational Awareness and Hazard Avoidance.

FIG. 20 exhibits another schematic view of a ground vehicle which utilizes Situational Awareness and Hazard Avoidance.

FIG. 21 offers a schematic view of yet another alternative embodiment of the present invention, showing an aircraft landing on the deck of an aircraft carrier.

FIG. 22 is a view of a vehicle, which is equipped with one embodiment of the present invention, and which is approaching several obstacles in an intersection.

FIG. 22A provides an enlarged view of the apparatus shown in FIG. 22.

FIG. 23 shows a helicopter which is equipped with one embodiment of the present invention, and which is approaching other aircraft and a land-based obstacle.

FIG. 23A is an enlarged view of the apparatus shown in FIG. 23.

FIG. 24 shows a unmanned aerial vehicle which is equipped with one embodiment of the present invention, and which is approaching other aircraft and a land-based obstacle.

FIG. 25 shows a naval vessel which is equipped with one embodiment of the present invention, and which is approaching other watercraft.

FIG. 25A is a view of two vehicles on a highway.

FIG. 25B is another view of the two vehicles shown in FIG. 25A.

FIG. 25C is a view of a fighter jet and a helicopter.

FIG. 26 is a schematic diagram that illustrates how apparatus employed by one embodiment of the present invention produces separated, dynamically pointed beams.

FIG. 27 is a schematic diagram that illustrates two-beam measurement geometry.

FIG. 28 is a flow chart which illustrates how the apparatus used in one embodiment of the present invention finds a target.

FIG. 29 is a schematic diagram of a mass producible waveform generator.

FIG. 30 is a schematic diagram of a low-noise photonic receiver for miniaturization and mass production.

FIG. 31 is a schematic diagram which illustrates integrated signal processing for miniaturization and mass production.

FIG. 32 reveals two vehicles on a roadway. One of the vehicles is equipped with one embodiment of the present invention, which is able to detect a deer crossing the road.

FIG. 32A is an overhead view of the two the vehicles shown in FIG. 32.

FIG. 33 is another view of the vehicles on the road, and depicts one vehicle avoiding the deer crossing the highway.

FIG. 33A is an overhead view of the vehicles shown in FIG. 33.

FIG. 34 presents another view of the two vehicles after a collision between the vehicles has been avoided.

FIG. 34A presents another view of the two vehicles after a collision with the deer has been avoided.

FIG. 35 offers a schematic diagram of a fiber coupled, Doppler LIDAR based navigation sensor system.

FIG. 36 offers a schematic diagram of a detector in a core unit.

FIG. 37 offers a schematic diagram of a transceiver both transmitting and receiving light.

FIG. 38 offers a schematic diagram of one embodiment of a transceiver: a fiber coupled telescope with a waveplate.

FIG. 39 offers a schematic diagram of a navigation sensor connected to a navigation computer. Item 394 is equivalent to item 12

FIG. 40 is a graph that plots velocity error versus distance to target in meters.

FIG. 41 is a graph that plots velocity error versus distance between sensors in centimeters.

FIG. 42 is a graph that plots velocity error versus target angle.

FIG. 43 is a graph that plots velocity error versus velocity of target.

FIG. 44 is a schematic diagram that shows one configuration of the telescopes and the core.

FIG. 45 depicts a helicopter with telescopes on an extendable boom.

FIG. 46 illustrates a fighter jet with telescopes deployed on drones.

FIG. 47 illustrates a bomber aircraft with telescopes deployed on missiles.

FIG. 48 shows an aircraft equipped with one embodiment of the present invention as it flies toward a aircraft carrier.

FIG. 49 furnishes a view of the aircraft in FIG. 48 as it lines up a landing on the aircraft carrier.

FIG. 50 depicts the aircraft from FIG. 49 as it lands on the aircraft carrier.

FIG. 51 is a graph that plots frequency versus time for three waveforms.

FIG. 52 is a three-dimensional graphs that shows the key vectors measured and

calculated to determine groundspeed, altitude and other navigation parameters.

FIG. 53 is a front view of a roll angle.

FIG. 54 is a side view of a pitch angle.

FIG. 55 is a top view of a yaw angle.

### DETAILED DESCRIPTION

### Overview of Preferred & Alternative Embodiments the Invention

The present invention enables stealthy, self-reliant, accurate, long-distance navigation by using laser light and coherent receivers configured to provide speed in the sensor frame of reference, and with respect to objects and other vehicles in its environment. The use of Continuous Wave (CW) laser light means detection by adversaries is extremely difficult and also provides high precision measurements. Coherent receivers allow very high signal-to-noise ratio (SNR) measurements of speed along the laser beam line of sight with very low probability of interference from other nearby laser based signals. For ground and aerial systems distance and velocity measurements are relative to the reference plane formed by the ground. Using more than one beam, the present invention measures speed with respect to the ground or the other objects/vehicles in more than one direction allowing either 2-D or 3-D position determination as well as other useful vehicle state parameters, including the speed and direction of the other objects/vehicles in its environment (sensor reference frame). A clock and heading information updates using compass, gyroscope, star tracker and/or a terrain matching system completes the fully self-contained navigation system.

In situations where it is not desired or feasible to provide human control or when human abilities are inadequate for safe operations, it is necessary for vehicles to autonomously plan their trajectory, navigate to their destination and control their position and attitude. To safely and reliably accomplish this objective, they must be able to sense their environment with enough accuracy and precision to make and execute appropriate decisions. Clutter free, high signal to noise ratio velocity and range measurements offer a particularly elegant solution.

Specific problems demanding this system include navigating or landing on heavenly bodies without human aid, landing on Earth with or without human aid, rendezvous and proximity operations (inspection, berthing, docking) in space, driverless cars, trucks and military vehicles, aerial vehicles in GPS denied environments.

Current navigation systems use inertial measurement systems that accumulate velocity errors relatively quickly leading to large uncertainties in a vehicle's position after relatively short periods of time. Space-based or ground based beacons like GPS or LORAN (Long Range Navigation) can provide position information through triangulation techniques but are susceptible to hostile actors who can either jam these signals or worse spoil them such that they provide undetectably incorrect position readings. Previous systems use sensors like accelerometers, oscillators, gyroscopes, odometers and speedometers of various types, GPS signals, other triangulation beacon systems, cameras, RADAR (Radio Detection and Ranging), SONAR (Sound Navigation and Ranging), and LIDAR (Light Detection and Ranging).

These fall into two groups: onboard sensors and externally delivered information signals. The limitations of the onboard sensors are their systematic errors which accumulate over time and give inadequate knowledge for accurate navigation, and a high degree of multi-target clutter, confusing signal interpretation. The limitation of externally delivered signals is their availability. They are not available underground or in space and can be jammed or spoofed on Earth.

Current navigation systems use inertial measurement systems that accumulate velocity errors relatively quickly leading to large uncertainties in a vehicle's position after relatively short periods of time. Space-based or ground based beacons like GPS or LORAN can provide position information through triangulation techniques but are susceptible to hostile actors who can either jam these signals or worse spoil them such that they provide undetectably incorrect position readings. The present invention allows accurate navigation with generally insignificant errors over long periods of time using only onboard instruments allowing vehicles to be self-reliant for navigation information.

Previous on-board navigation systems can use radar to provide navigation information superior to inertial measurement systems that use gyros or accelerometers but these also provide hostile actors with knowledge of the trajectory of the vehicle. The present invention allows accurate navigation and very low probability of detection by other entities and faster environmental situational awareness.

The key advantages of the present invention over previous systems are the low systematic error and the low chance of detection due to the nature of the light used to determine the navigation parameters. The uniqueness of the present invention's detection methodology provides clutter free, closed-channel signal acquisition making the system able to operate in a high target traffic environment.

Combining both reference sensors and sense-and-avoid sensors into a single system will provide critical data at an accuracy and speed unavailable until now.

The reference sensor allows the sense and avoid sensor to deliver referenced velocities for the objects in its environment. In turn the situational sensors provide additional data that can improve the reference sensor measurements, especially for guidance, navigation and control purposes.

The present invention provides key information to vehicle guidance, navigation and control systems, specifically, velocity vectors and range, with derivable information about surface relative attitude, side-slip angle, angle of approach, and altitude. These parameters measured with high accuracy enable safe and reliable human driven and autonomous cars and trucks and enable aerial vehicles (with and without pilots) to navigate without GPS or other external signals. In current cars, one embodiment of the present invention enables automobiles to recover from currently uncontrollable spins and situations where the vehicle is sliding sideways or spinning and cannot determine their position or direction.

One embodiment of the present invention enables safe and reliable human driven and autonomous cars and trucks and enables aerial vehicles (with and without pilots) to navigate without GPS or other external signals. In current cars, one embodiment enables automobiles to recover from currently uncontrollable spins and situations where the vehicle is sliding sideways or spinning and cannot (with previous systems) determine their position or direction.

The present invention may be implemented in ADAS 3-5 (Advanced Driver Assistance) vehicles, both civilian and military as well as piloted and unpiloted aircraft, especially those requiring VTOL (Vertical Take Off and Landing) and the capability to fly without GPS navigation signals. Another embodiment of the invention may be used as navigation sensors for crew and cargo delivery to planetary bodies such as the Moon, Mars or asteroids by commercial space companies.

### II. A Detailed Description of One Embodiment of the Invention

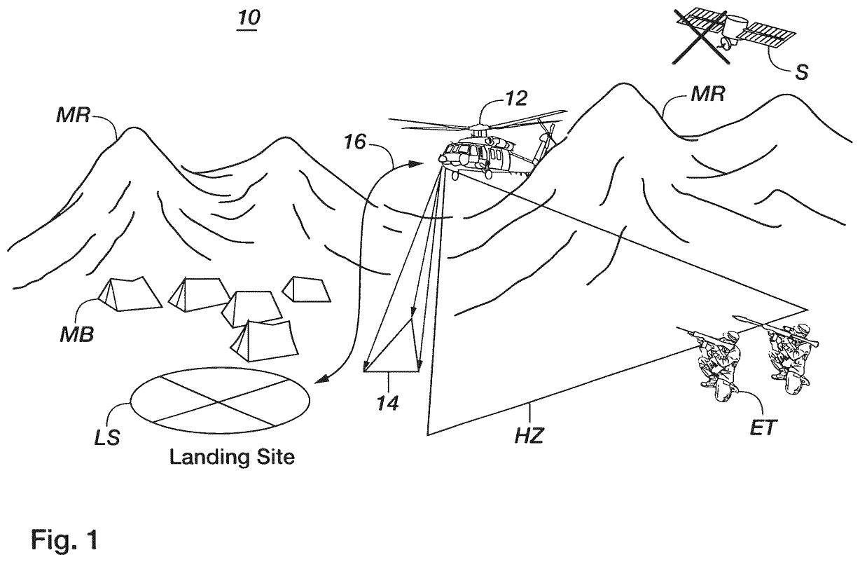

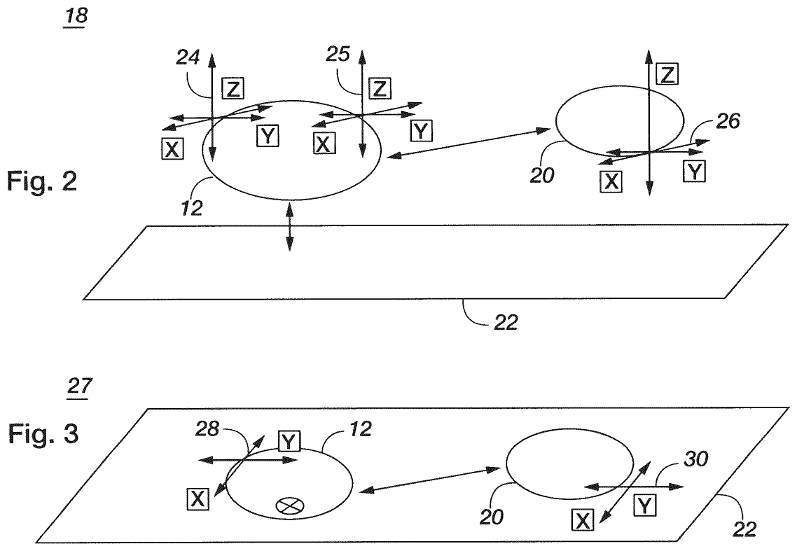

FIG. 1 is a generalized view of one embodiment of the present invention 10, which is utilized in a GPS Denied Environment. A GPS satellite S is shown over the landscape shown in FIG. 1, but is unavailable to provide navigation services, due to the efforts of hostile or unfriendly forces in the area. These hostile or unfriendly forces may be jamming or spoiling GPS signals with specialized radios.

An airborne vehicle 12, such as a helicopter, is shown flying over a hostile zone HZ bordered by a mountain range MR. The hostile zone HZ is populated by enemy troops ET, who are capable of firing on the helicopter 12.

The helicopter 12 is attempting to avoid the mountain range MR, as well as the enemy troops ET, and is attempting to land on a landing site LS near a friendly military base MB.

The helicopter 12 has an on-board navigation system which embodies the various embodiments of the present invention, and which is described in detail below. The on-board navigation system illuminates a portion of the ground 14, and computes the optimal approach path 16 that will enable the helicopter 12 to land safely on the landing site LS.

FIG. 2 is a schematic view 18 of generalized sensor system reference frames for three dimensions that are employed by the present invention. FIG. 2 shows both an airborne vehicle, 12, and a target 20. FIG. 2 depicts a universal reference frame 22, a three-dimensional vehicle reference frame 24, a sensor reference frame 25, and a three-dimensional target reference frame 26. The universal reference frame 22 is generally defined by a plane that is associated with the terrain below the vehicle 12 and the target 20. In space, it could be defined by the features of another spacecraft.

Both the vehicle reference frame 24 and the target reference frame 26 are characterized by a Cartesian Coordinate set of three axes. The directions defined by the axes are labeled x, y and z. These directions and the rotation around each axis define six degrees of freedom.

The on-board navigation system implemented in one embodiment of the invention illuminates a portion of the universal reference frame 22, one or more targets 20 and/or other objects. This on-board navigation system utilizes a variety of sensors, which are described in detail in this Specification. Unless these sensors are placed exactly at the center of mass and center of inertia of the vehicle 12, then there is a difference between the sensor reference frame 25 and the vehicle reference frame 24.

FIG. 3 is a similar schematic view 27 of generalized sensor system reference frames 18, but only shows the two dimensions of freedom available for a ground vehicle that are employed by the present invention. FIG. 3 shows a vehicle, 12, and a target 20. FIG. 3 depicts a universal reference frame 22, a planar vehicle reference frame 28, and a planar target reference frame 30. The universal reference frame 20 is generally defined by the plane that is associated with the terrain on which the vehicle 12 and the target 20 are located.

Both the vehicle reference frame 28 and the target reference frame 30 are characterized by a Cartesian Coordinate set of two axes. The directions defined by the axes are labeled x and y. These directions and rotation around the vertical or yaw define three degrees of freedom.

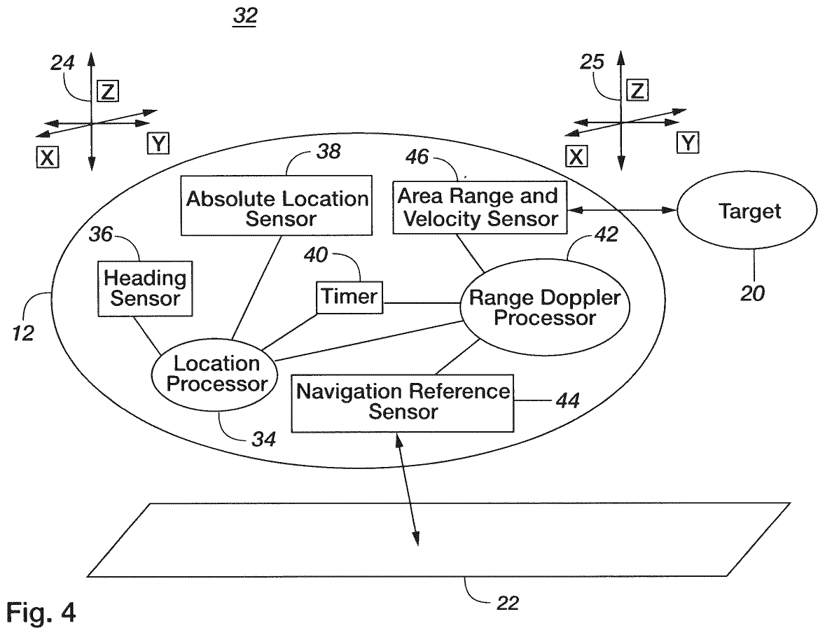

FIG. 4 provides a schematic view 32 of a generalized vehicle 12. The location of the vehicle 12 is characterized by three Cartesian Coordinates, and is measured along the three axes of a vehicle reference frame 24 located by definition at the center of mass of the vehicle. The generalized vehicle 12 carries a navigation system on-board which implements the various embodiments of the present invention. A location processor 34 is connected to a heading sensor 36, an absolute location sensor 38, and a timer 40. A range Doppler processor 42 is connected to a Navigation Reference Sensor (NRS) 44 and an Area Range & Velocity Sensor (ARVS) 46.

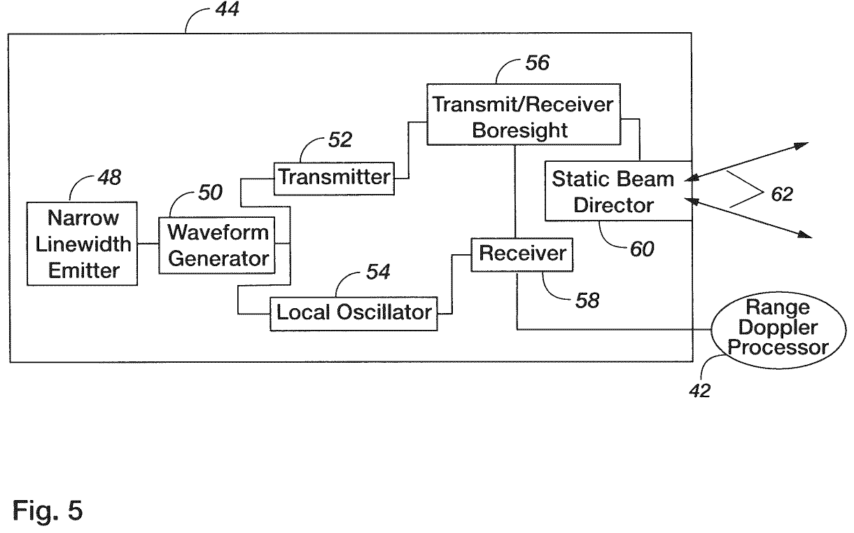

FIG. 5 offers a schematic block diagram which shows the details of the Navigation Reference Sensor (NRS) 44. A narrow linewidth emitter 48 is connected to a waveform generator 50, which, in turn, is coupled to both a transmitter 52 and a local oscillator 54. The transmitter 52 is connected to a transmit/receive boresight 56 and a receiver 58. The local oscillator 54 is also connected to the receiver 58. A static beam director 60 is connected to the transmit/receive boresight 56. The static beam director 60 emits and collects LIDAR beams 62.

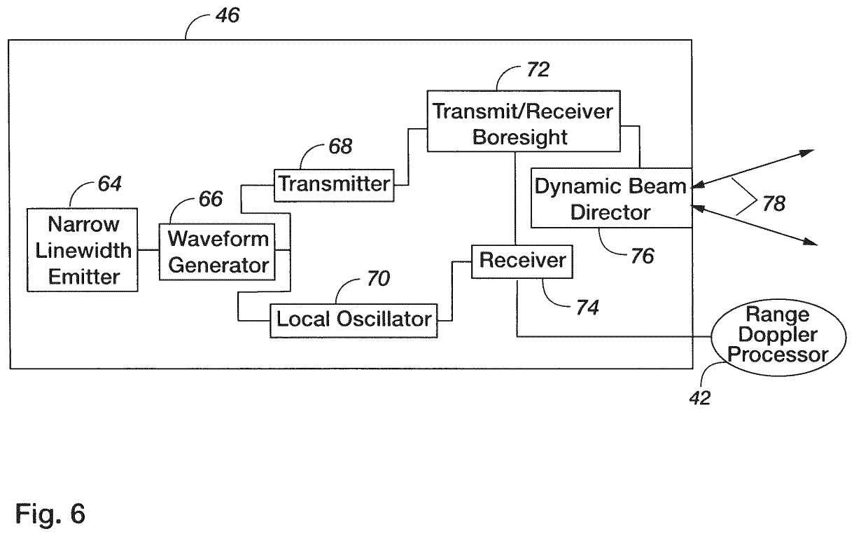

FIG. 6 offers another schematic block diagram which shows the details of an Area Range & Velocity Sensor (ARVS) 46. A narrow linewidth emitter 64 is connected to a waveform generator 66, which, in turn, is coupled to both a transmitter 68 and a local oscillator 70. The transmitter 68 is connected to a transmit/receive boresight 72 and a receiver 74. The local oscillator 70 is also connected to the receiver 74. A dynamic beam director 76 is connected to the transmit/receive boresight. The dynamic beam director 76 emits and collects variable direction LIDAR beams 78.

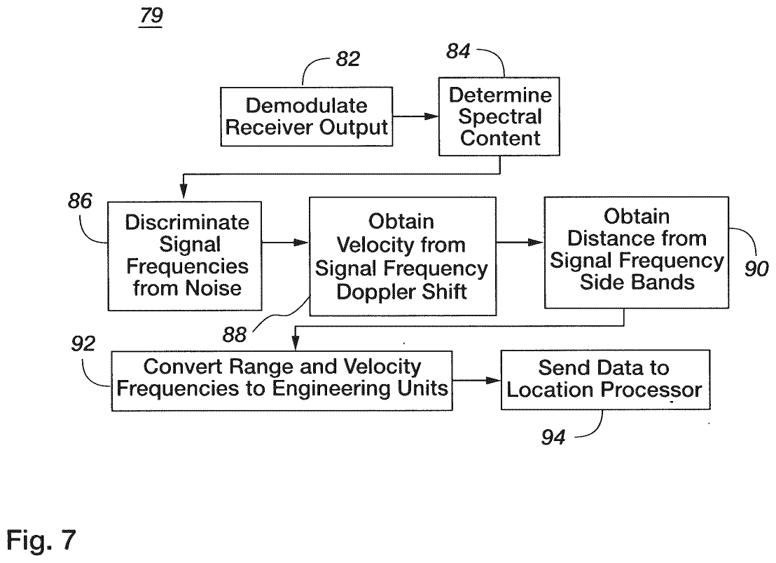

FIG. 7 is a flow chart 79 that portrays method steps that are implemented by the Range Doppler Processor 42 in one embodiment of the present invention.

82 Demodulate receiver output.

84 Determine spectral content.

86 Discriminate signal frequencies from noise. These signal frequencies are

the Doppler shifted frequency and the sidebands on the Doppler shift frequency.

88 Obtain velocity from signal frequency Doppler Shift. By determining the Doppler frequency itself, the speed along the beam direction of travel is calculated.

90 Obtain distance from signal frequency side bands. By determining the sideband frequencies, the range to the target or object is calculated.

92 Convert range and velocity frequencies to engineering units.

94 Send data to Location Processor.

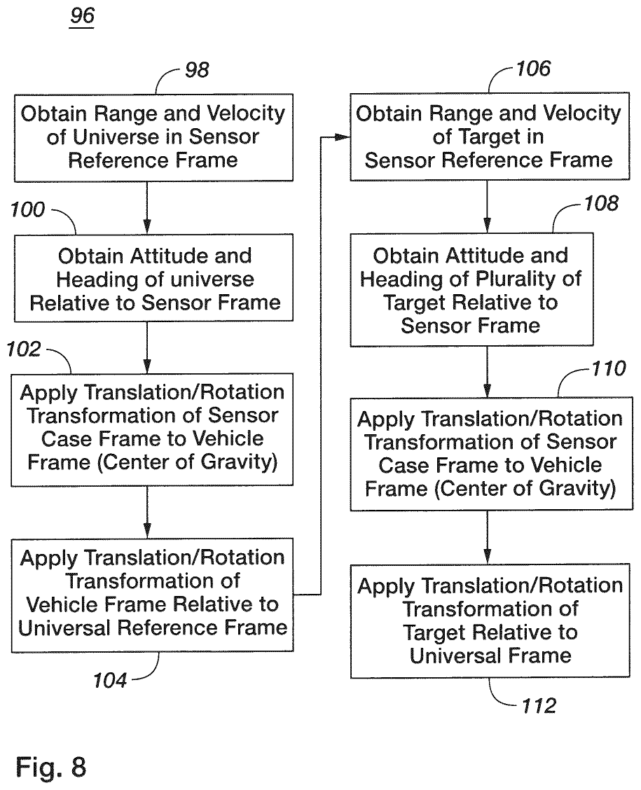

FIG. 8 supplies a flow chart 96 that illustrates method steps that are implemented by the Location Processor 34 in one embodiment of the present invention. The steps shown in FIG. 8 are:

98 Obtain range and velocity of universal reference frame in sensor reference frame.

100 Obtain attitude and heading of universal reference frame relative to sensor frame.

102 Apply translation/rotation transformation of sensor case frame to vehicle frame (center of gravity).

104 Apply translation/rotation transformation of vehicle frame relative to universal reference frame.

106 Obtain range and velocity of target in sensor reference frame.

108 Obtain attitude and heading of a target relative to sensor frame.

110 Apply translation/rotation transformation of sensor case frame to vehicle frame (center of gravity).

112 Apply translation/rotation transformation of target relative to universal reference frame.

The steps labeled 98, 100, 102, and 104 converts to engineering units the range and velocity of the vehicle 12 reference frame relative to a universal reference frame.

The steps 106, 108, and 110 convert to engineering units and transform coordinates for the range and velocity of the vehicle 12 reference frame relative to plurality of target reference frames.

Step 112 transforms coordinates from the target reference frames to the universal reference frame.

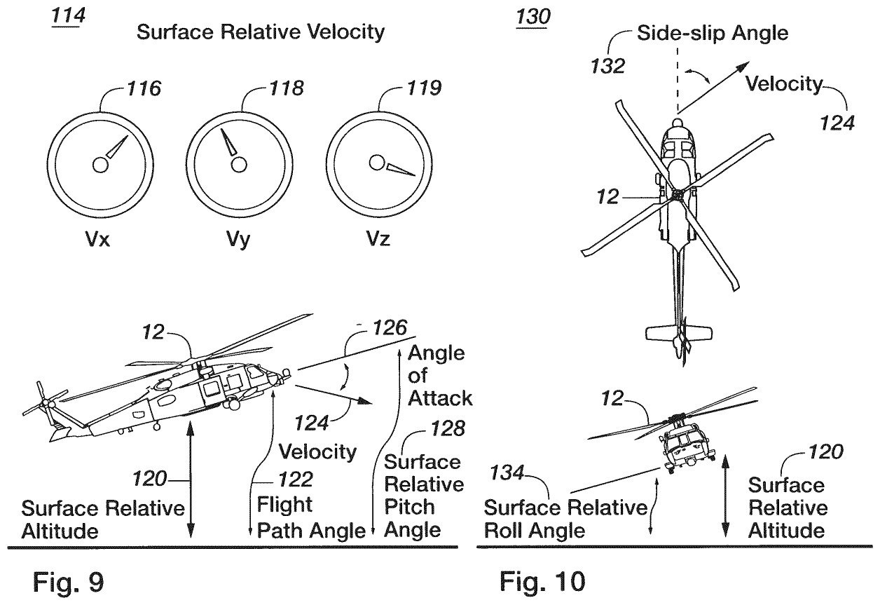

FIG. 9 is an illustration 114 of the displays that convey navigation information to the pilot of the vehicle 12. Surface relative velocity is presented on instruments that show Vx 116, Vy 118 and Vz 119. FIG. 9 also depicts other navigation information for the vehicle 12, including surface relative altitude 120, flight path angle 122, the velocity vector 124, the angle of attack 126 and the surface relative pitch angle 128.

FIG. 10 is an illustration 130 that portrays navigation attributes concerning the vehicle 12, including the side-slip angle 132 and the surface relative roll angle 134.

### III. Embodiments of the Invention that May be Used for GPS-Denied Environments

In one embodiment, the NRS 44 uses a coherent LIDAR system with a static beam director 62 to measure vehicle reference frame 24 speed and distance relative to the universal reference frame 22 in one or more directions, such that said speed and distance measurements can be used by the Range Doppler Processor 42 and the Location Processor 34 to determine planning, guidance, navigation and control parameters. The NRS 44 uses a narrow linewidth emitter 48 modulated by a waveform generator 50 to provide a transmitted signal to the universal reference frame 22 and a Local Oscillator 54 that goes to the receiver 58. The transmitter signal is aligned to the receiver 58 by the boresight 56 and pointed to the universal reference frame 22 by the static beam director 60.

In one embodiment of the present invention, an Area Range and Velocity Sensor (ARVS) 46 is employed to determine the location and velocity of one or more targets 20. The target 20 may be another aircraft, a building, personnel or one or more other objects.

In one embodiment of the invention, the Navigation Reference Sensor (NRS) 44 may utilize a GPS receiver, or a terrain relative navigation camera and map, or a star tracker to obtain its initial location.

The ARVS 46 uses a coherent LIDAR system with a dynamic beam director 76 to measure vehicle reference frame 24 speed and distance relative to a target reference frame 26 in one or more directions, such that the speed and distance measurements can be used by the Range Doppler Processor 42 and the Location Processor 34 to determine planning, guidance, navigation and control parameters. The ARVS 46 uses a narrow linewidth emitter 48 modulated by a waveform generator 50 to provide a transmitted signal to a target 20 and a Local Oscillator 54 that goes to the receiver 58. The transmitter signal is aligned to the receiver 74 by the boresight 72 and pointed to a target 20 by the dynamic beam director 76.

In one embodiment, the Absolute Location Sensor (ALS) 38 is used to determine an absolute location in the universal reference frame of a vehicle or platform 12 at certain intervals. The ALS 38 provides the starting fix for the location processor. Alternative methods for obtaining a starting location include using a GPS receiver, a terrain matching camera, a LIDAR system, and/or a star tracker.

In one embodiment, one or more heading sensors 36 provide the absolute orientation to the universal reference frame 22 of the vehicle 12. Heading sensors 36 indicate the direction of travel with respect to the universal reference frame 22.

Alternative methods for determining the direction of travel relative to some reference frame include using a compass, a star tracker, or a terrain matching system.

One embodiment of the invention uses a timer to measure durations of travel over periods of constant speed and heading. The accuracy of the clock is driven by the need for accuracy in the location that is being determined. Errors in timing translate directly into errors in location. Each user has their own requirement on location accuracy, and, therefore, on the timer accuracy. The clock has a level of precision and accuracy that are sufficient to meet the navigation error requirements.

The user's navigation error requirements determines the clock or timer accuracy and precision. Since location is given by the product of velocity and time, location error is related linearly to clock errors for a given velocity.

The Range-Doppler Processor 42 combines the Doppler-shift information from the Doppler-shift receivers in the NRS 44 and ARVS 46.

One or more processors demodulate, filter, and convert the collected time-domain signals into frequencies from where spectral content information is retrieved. This information includes Doppler frequency shifts that are proportional to target velocity, and sideband frequencies that are proportional to the distance to a target. The Range Doppler Processor contains one or more computer processor units (CPU). One of these CPU's may accomplish the filtering task, while another demodulates the signal.

The Location Processor 34 and its algorithm 96 combine heading, range, velocity and timing and previous locations data from various sensors (guidance, navigation and control computer).

All of the processors and CPU's described in this Specification are connected to memories. Each of the memories store specially designed software which governs the operation of the processors and CPU's. The CPU's process inputs, change state, and generate outputs that create benefits for users.

Each NRS and ARVS 46 includes a narrow linewidth emitter, which is a coherent electromagnetic radiation source with a linewidth controller such as a grating or filter. The linewidth of the source provides the accuracy limitation to the range and velocity measurements. The linewidth of the emitter refers to the spectral distribution of instantaneous frequencies centered about the primary frequency but containing smaller amplitudes on either side, thus reducing the coherence of the emitter. One embodiment of the emitter is a semiconductor laser with a gain-limited intra-cavity spectral filter.

In one embodiment, the linewidth is 100 kHz or less:

$$f = c / λ = 3 \times {10}^{8} m / sec divided by 1.5 \times {10}^{- 6} m = 200 THz ;$$

or 1 part in 10-12. This linewidth is scalable with the frequency of the emitter.

A waveform generator manipulates the frequency, phase, or amplitude of the emitter to serve as an interrogation or communication method to the carrier wave. Frequency, phase, or amplitude modulation is performed by applying perturbations in time or space, along the emitter's path, thus adjusting the waveform. One embodiment of the modulator is an electro-optic crystal. A second embodiment of the modulator is an acousto-optic crystal. Another embodiment of the modulator is variations in current or temperature of an emitter.

The modulator creates a spectrally pure, modulated carrier frequency that has an identically (1 part in 10³) linear frequency increase as a function of time, from which distance measurements are made entirely in the frequency domain.

One embodiment of the invention utilizes a very high signal-to-noise Doppler-Shift Receiver. The Doppler frequency shift of radiation reflected from moving targets, planes, or references are obtained in the frequency domain using Doppler-shift receivers. In these receivers, the signal electromagnetic field to be detected is combined with a second electromagnetic field referred to as the Local Oscillator 70. The local oscillator field is very large compared to the received field, and its shot noise dominates all other noise sources. The spectrally coherent shot noise of the local oscillator serves as a narrow bandwidth amplifier to the signal, providing very high signal-to-noise, surpassing the signal-to-noise of the more common direct detection receivers. The high degree of coherence obtained by the Narrow Linewidth Emitter 64 and Local Oscillator 70 prevent stray light or external emitter electromagnetic radiation to be detected by the Receiver 74. This unique capability enables high signal-to-noise detection even in very high traffic electromagnetic environments. Each Receiver 58 & 74 obtains a unique measurement of distance and velocity along its pointing line of sight. In this embodiment, high signal-to-noise ratio is generally greater than 10:1.

In one embodiment of the invention, the sensor receivers are boresighted with the emitters. The boresight of the electromagnetic radiation direction between the transmitter 68 and the receiver 74 allows the target-reflected transmitted radiation to be captured by the receiver 74. Every vehicle will have a different range of angular space based on its needs. It is necessary to use more than one emitter when there is more than one translational degree of freedom. A train has one translational degree of freedom. A car has two degrees, and airplane or spacecraft has three.

In one embodiment of the invention, the beam director is typically fixed in the NRS 44, but is movable in the ARVS 46. The beam director determines where the transmitted radiation is pointed, and, therefore, determines a range to a selected target 20. The beam director both transmits and collects the return radiation. There is at least one beam director in the NRS and the ARVS. There is one beam director for each beam. For an aircraft, there are at least three individual static beam directors. For a car, there are at least two. There are as many dynamic beam directors as are needed for situational awareness.

In one embodiment of the present invention, a vehicle 12 carries the combination of hardware and/or software that is employed to implement the invention. In one embodiment, the vehicle 12 is a helicopter, or some other aircraft. In another embodiment, the vehicle 12 may be ground-based, like an automobile or a truck. In yet another embodiment, the vehicle 12 may be a satellite in orbit. In still another alternative implementation of the invention, the combination of hardware and/or software that is used to operate the invention may be installed on a stationary platform, such as a building or utility pole.

In one embodiment of the invention, the Area Range and Velocity Sensor (ARVS 46) may utilize a scanning time of flight LIDAR system, or a flash time of flight LIDAR system, or a number of cameras with photogrammetry.

In one embodiment, the Absolute Location Sensor 38 may include a GPS receiver. In another embodiment, the Absolute Location Sensor 38 may include a terrain relative navigation camera and map.

The Heading Sensor 36 may implement the present invention using a compass, a star tracker, a terrain matching system or an inertial measurement unit.

The timer may comprise any oscillator with sufficient accuracy to meet navigation requirements and a counter.

The Range Doppler Processor (RDP) 42 may include any microprocessor which is able to combine the Doppler-shift information from the Doppler-shift receivers in the NRS 44 and ARVS 46. These functions include demodulation, filtering, and converting the collected time-domain signals into frequencies from where spectral content information is retrieved. This information includes Doppler frequency shifts proportional to target velocity, and distance to target.

The output of the Doppler-shift receivers (58 & 74) are demodulated. The Doppler-shift receiver or optical detector demodulates the optical waveform returning from the target 20 by mixing it with the Local Oscillator 54 (also an optical waveform with the same (called homodyne) or very nearly same (called heterodyne) frequency). When the output of the Doppler-shift receivers are demodulated, then the spectral content of the receiver output over a limited range is determined. The demodulation step moves or removes the frequencies in the spectrum that are unwanted, and allows the signal to be processed. This step narrows the range of frequencies where the next steps look for and specifically determine the signal frequencies.

In the various embodiments of the invention, the Location Processor 34 may be any microprocessor that is able to combine heading, range, velocity, timing and previous location data from the various sensors (guidance, navigation and control computer).

In one embodiment of the invention, the Narrow-Linewidth Emitter (NLE) is a semiconductor laser combined with an intra-cavity filter. In another embodiment, a fiber laser with an embedded grating may be employed. In other embodiments, the NLE may include a solid state laser with active cavity length control, a RADAR system, or a microwave source.

In the various embodiments of the invention, the waveform generator or waveform generator may utilize an electro-optical crystal, an acousto-optical crystal or a direct laser control with temperature. The waveform generator controls the frequency content of the transmitted beam. The frequency of the laser may be changed by changing the temperature of the laser. The frequency of the laser may also be changed by changing the current through the laser.

In one embodiment of the invention, the Doppler shift receiver, which is selected so that it provides a very high signal-to-noise ratio, includes an interferometer, a filter-edge detector, a homodyne detector or a heterodyne detector.

A boresight circuit that is used to implement the invention may offer fixed or active control. Any circuit which is capable of aligning the beams that are emitted by the transmitter and collected by the receiver may be employed.

In implementing the various embodiments of the present invention, the beam director may be designed so that it includes a telescope, a scanning mirror, microelectromechanical arrays of mirrors, phased arrays, a grating or a prism.

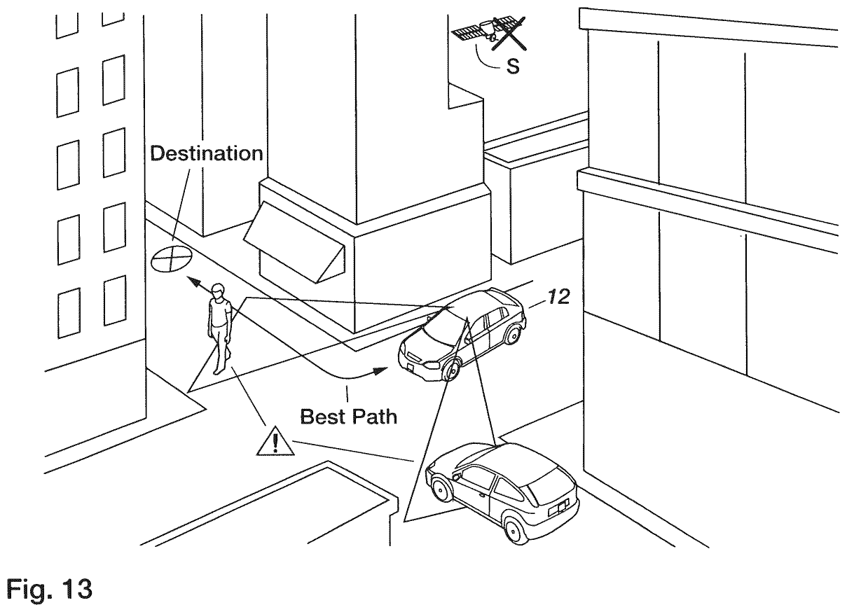

### IV. Operation of the Invention: FIGS. 13-21

In FIG. 1, the beam illuminating the hostile zone is produced by the Area Range and Velocity Sensor. In this embodiment, the ARVS uses two or more beams together. Target range, speed and direction are measured.

FIGS. 2 and 3 provides an illustration that indicates that surface contained systems only have two velocity vector components, and that aerial/space systems have three. Surface systems only have one angle free, which is yaw. Aerial/space systems have three: roll, pitch and yaw. Surface systems, therefore, have three degrees of freedom (3-DOF) while aerial/space have 6 degrees of freedom (6-DOF).

FIG. 4 illustrates the use of Doppler shifts to measure vehicle velocity for navigation relative to a reference frame (Navigation Reference Sensor), and simultaneously for situational awareness and navigation relative to objects and vehicles in the environment (Area Range and Velocity Sensor or ARVS). The NRS or ARVS may use any number of beams.

FIG. 5 illustrates the NRS, which has no ability to steer the direction of the beam(s) (static beam director).

FIG. 6 illustrates the ARVS and its ability to steer the direction of the beam(s) (dynamic beam director).

FIG. 7 shows the basic method of finding velocity and range from the Doppler return signal-used in both NRS and ARVS.

FIG. 8 shows the method of determining where the vehicle and the other targets are located in the reference frame, and their speeds.

FIG. 9 shows a display for an aerial vehicle pilot with the parameters that are measured. These measurements are outputs from the NRS.

FIG. 10 shows another version of the display. All the data comes from the NRS.

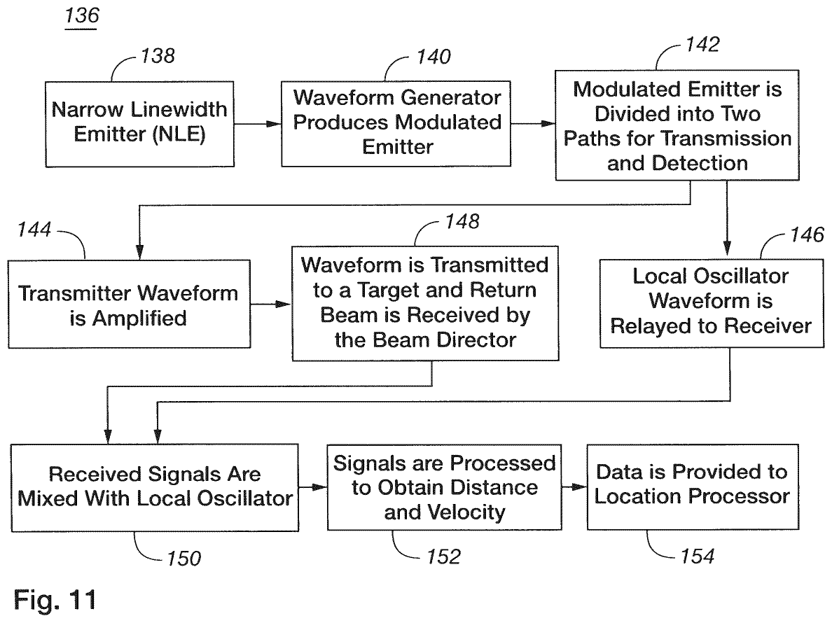

FIG. 11 supplies a view of a general method for building a Doppler or Coherent LIDAR system.

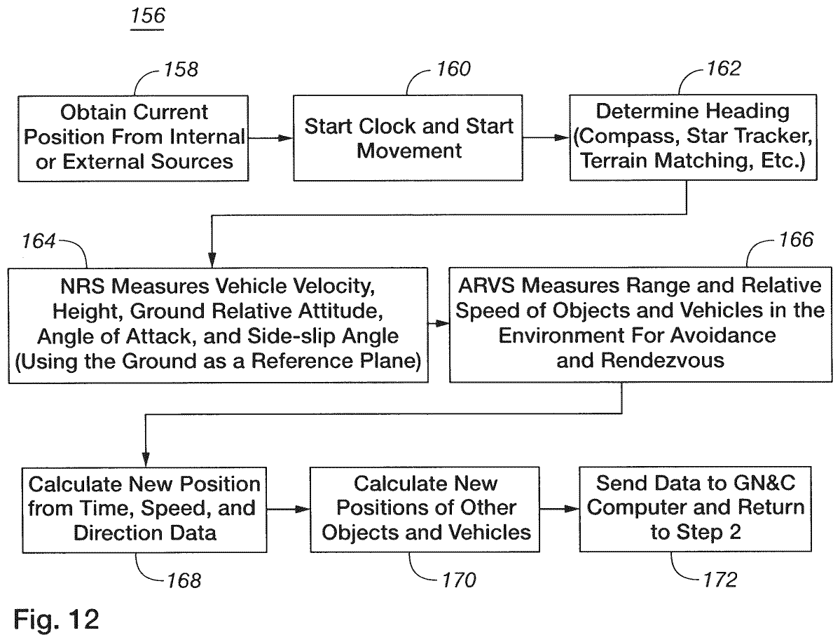

FIG. 12 depicts a method of keeping up with the location of a vehicle as it moves using the NRS and other available sensors and avoiding hazards using the ARVS.

FIG. 13 shows a car navigating through a large city where GPS signals are not available. The Reference Sensor enhances this navigation. FIG. 13 also shows the Area Sensor providing local navigation information about hazards by probing other vehicles or objects with beams moving essentially horizontal to the ground.

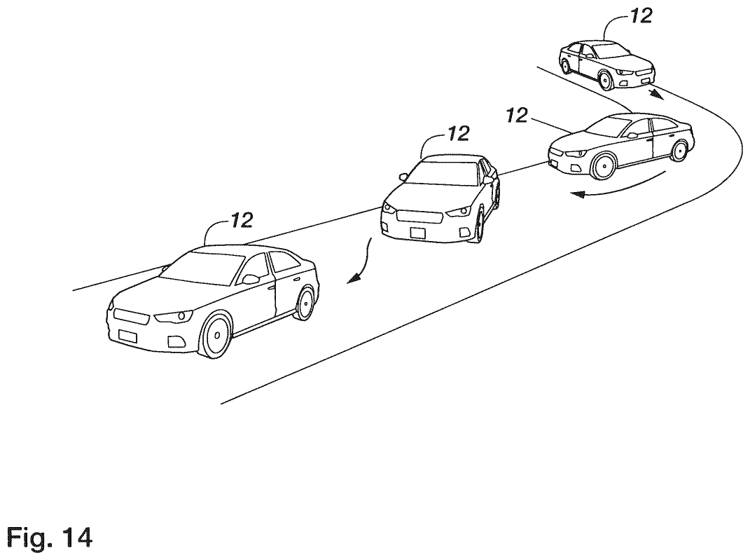

FIG. 14 shows a car losing control on a turn and then recovering. This control recovery possible because our system of Reference and Area Sensors along with other sensors already available like an IMU, cameras, etc. allow the car to keep up with where it is in rotation and translation and therefore use its control mechanisms to recover safely.

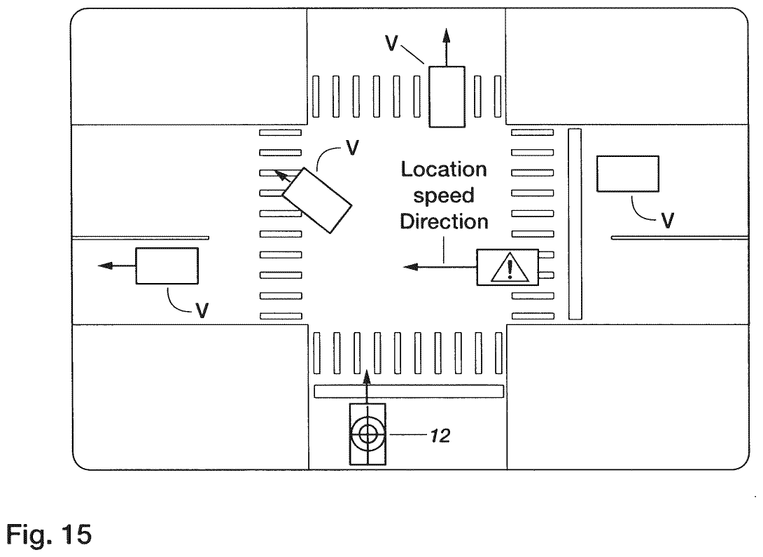

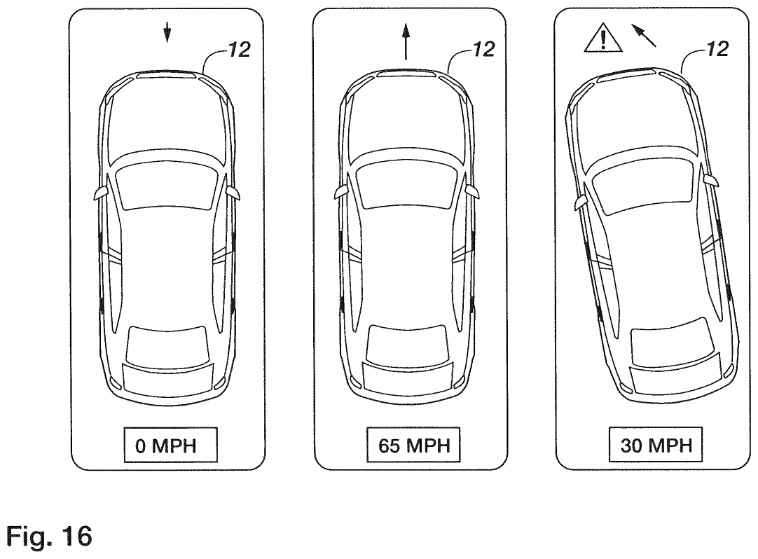

FIG. 15 shows a display that may be used in the vehicle shown in FIG. 13.

FIG. 16 shows another display that may be employed in the vehicle in FIG. 14.

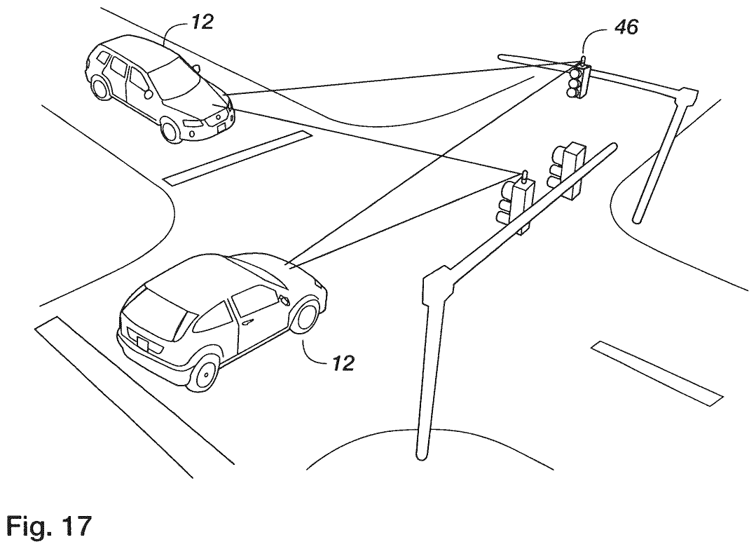

FIG. 17 depicts the measurement of the location, speed and direction of vehicles in the vicinity of an intersection. Autonomous cars have the ability to receive data like this from external sources to enable better traffic flow management.

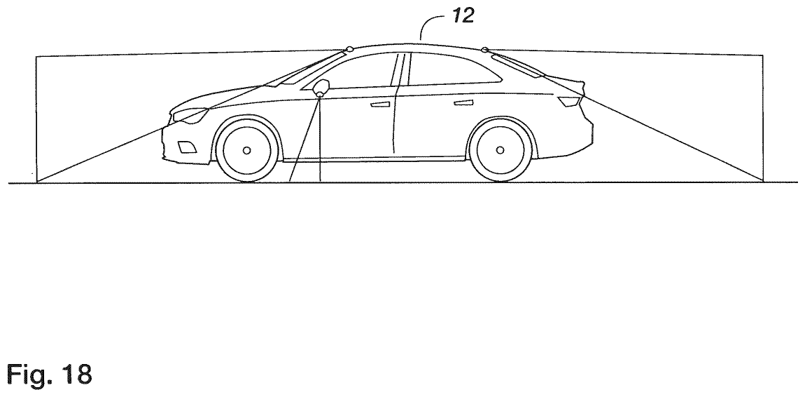

FIG. 18 shows the field of view of the Area Sensors mounted at the top of the front and rear windshields from a side view.

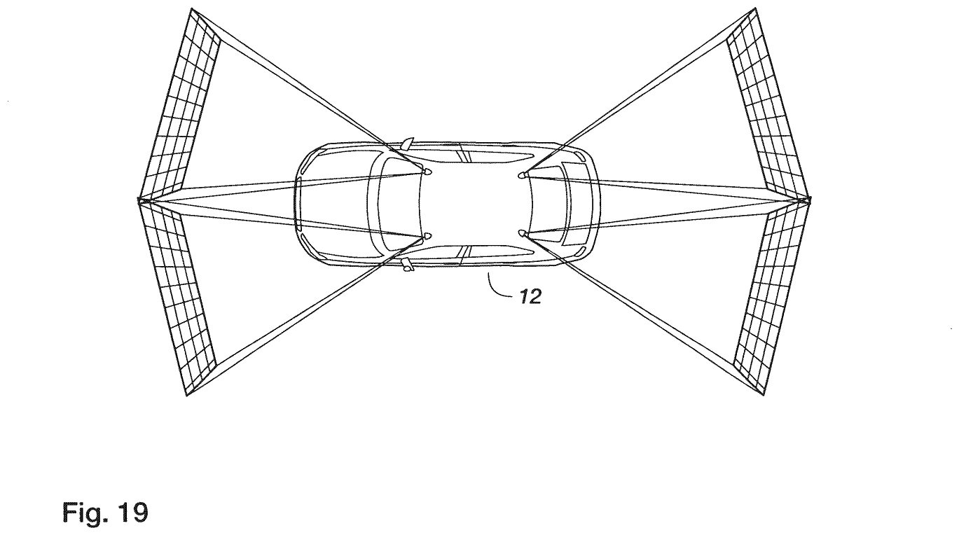

FIG. 19 shows the field of view of the Area Sensors mounted at the top of the front and rear windshields from a top view.

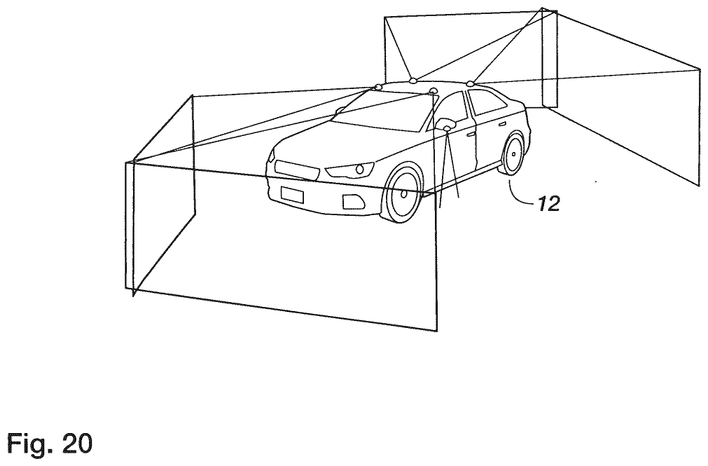

FIG. 20 is a view of a vehicle combined with situation awareness and hazard avoidance.

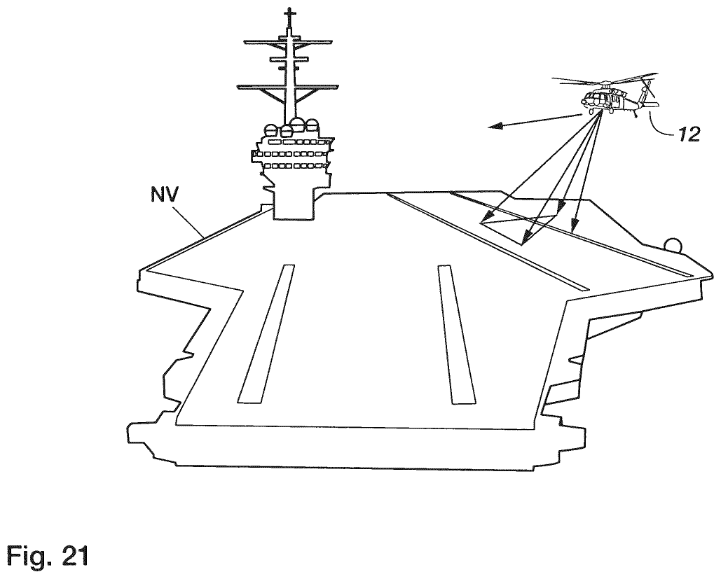

FIG. 21 shows the use of the Navigation Reference Sensor for landing a helicopter on a ship deck. Three beams are required.

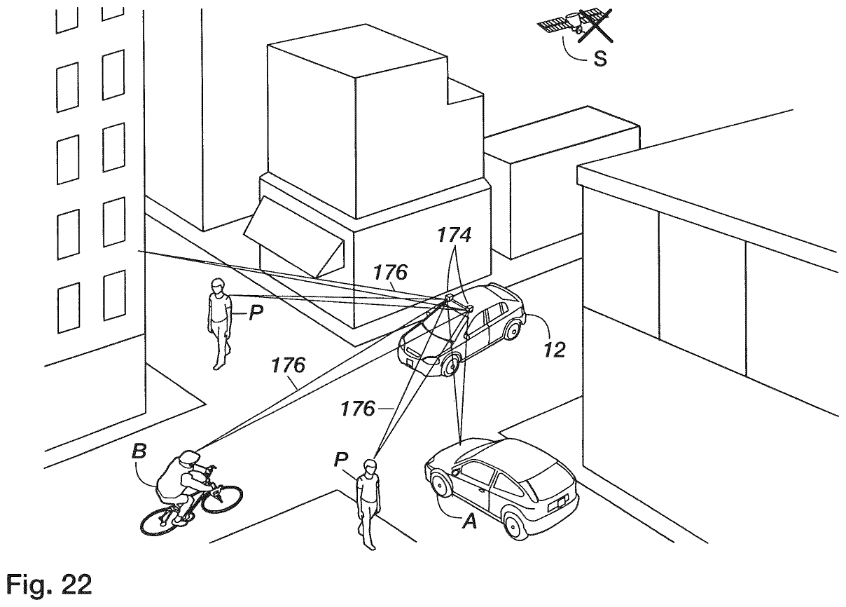

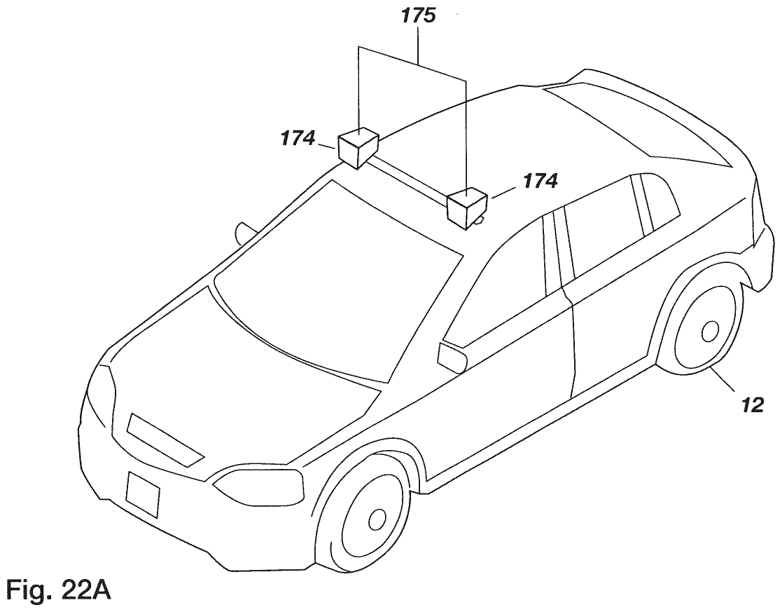

FIG. 22 is similar to FIG. 13, except that FIG. 22 explicitly shows the illumination of each object with two beams instead of only one.

### V. Detailed Descriptions Alternative Embodiments of the Invention that May be Used in Combination with Conventional and/or Autonomous Vehicles

### A. Implementations of the Invention

FIGS. 13-21 generally provide schematic illustrations of applications of alternative embodiments of the invention. FIGS. 13-20 pertain to vehicles 12 which generally travel, translate or otherwise move on, near or under the ground, while FIG. 21 pertains to the interaction of water-borne and airborne vehicles 12. All of the vehicles 12 shown in FIGS. 13-21 and described in Section II of the Detailed Description, such as cars, buses, trucks, trains, subways or other near-surface conveyances may utilize some combination of elements of the Invention shown in FIGS. 1-12 and described in Sections I, II, III and IV of the Detailed Description.

All of the vehicles 12 shown in FIGS. 13-21 and described in Section V of the Detailed Description provide specific enhanced navigation benefits to users of either conventional and/or driverless vehicles that are obtained only through the implementation of and combination with the elements of the Invention shown in FIGS. 1-12 and described in Sections I, II, III and IV of the Detailed Description.

In the case of ground vehicles such as automobiles and trucks, various implementations and/or variations of the navigation system hardware shown in FIGS. 1-12 may be installed near an engine, within a passenger compartment, in cargo storage areas, or in some other suitable space. This navigation system hardware is connected to sensors, emitters, antennas or other transmit and/or receive elements by conductive cables, fibers, wireless links, or other suitable data pathways. Some or all of these sensors, emitters, antennas or other transmit and/or receive elements may be mounted on, embedded in or otherwise affixed, coupled or attached to appropriate surfaces or structures of a vehicle, or on nearby surfaces and/or structures, such as roads, bridges, highways, freeways, embankments, berms, ramps, toll booths, walkways, drainage culverts, fences, walls, tracks, tunnels, stations, platforms, signage, traffic signals, motorcycles, bicycles, pedestrians, pets, animals, parking spaces, fire hydrants, standpipes, buildings or other facilities, appurtenances, appliances, equipment, cables, hazards, or objects.

### B. Collision Avoidance & Ancillary Safety Systems for Ground Vehicles that May be Used in Combination with the Enhanced Navigation System Provided by the Present Invention

According to Cartelligent, crash prevention systems typically include forward collision warning, auto-braking, lane departure warning, lane departure prevention, blind spot detection, and adaptive headlights:

“Forward collision warning systems use cameras, laser beams and/or radar to scan the road ahead and alert the driver to any objects in the road ahead. If the system detects an object that the driver does not appear to be reacting to it takes action. Some systems will sound an alert and prepare the brakes for full stopping power; others will apply the brakes automatically to prevent a crash.”

“Lane departure warning systems use cameras to detect the lane markings on the road. If the driver moves outside of the marked lanes without using the turn signal, an alert appears. Typically this is a visual alert combined with an audible tone or vibration. Lane departure prevention takes this one step further by gently steering the vehicle back into its lane. The driver can bypass this system at any point by turning the steering wheel.”

“Active blind spot detection systems, or blind spot monitoring systems, track vehicles as they approach the driver's blind spot. A visual alert is shown when another vehicle is currently occupying the blind spot. If the driver switches the turn signal to move into the occupied area, an audible tone or vibration is triggered. Blind spot intervention systems take this a step further by preventing the driver from moving into the space occupied by another vehicle.”

“Adaptive headlights react to speed and direction to move the beams up to 15 degrees in either direction. This can be helpful when driving around a corner at night, allowing the driver to see objects in the road ahead that would be invisible with standard beams. Some vehicles combine these with cornering lights that can provide up to 80 degrees of additional side view when the car is moving slower than 25 mph (such as in a parking lot).”

“A recent study by the Highway Loss Data Institute (HLDI) found that Acura and Mercedes-Benz vehicles with forward collision warning and active braking had 14% fewer insurance claims filed for property damage compared to the same models without the technology. Adaptive headlights have also been shown by the HLDI to reduce property damage claims by 10% compared to the same vehicle with standard headlights.”

“An IIHS survey of owners of vehicles with crash prevention technology found that the majority felt the system made them safer drivers and would want their next vehicle to have the same features. Depending on the vehicle, 20% to 50% of owners reported that the system had helped them to avoid a crash.”

### C. Automated Driving Using Advanced Control Technology that May be Used in Combination with the Present Invention

The automaker, BMW, has demonstrated how highly automated driving using advanced control technology can cope with all driving situations right up to the vehicle's dynamic limits.

The BMWBlog describes:

“New sensors can be used to move to the next stage-fully collision-free, fully automated driving. This latest milestone from the BMW Group is a further step on the road towards accident-free personal mobility in both driver-operated and fully automated, driverless vehicles.”

“Three hundred and sixty degree collision avoidance is based on precise position and environment sensing. Four highly advanced laser scanners monitor the surroundings of the research vehicle (a BMW i3) and accurately identify obstacles, such as pillars in multistorey car parks. An audible signal warns the driver in a potential collision situation.”

“As a last resort, for example if the vehicle is approaching a wall or pillar too quickly, it is also possible to initiate automatic braking, bringing the vehicle to a standstill with centimeter accuracy. If the driver steers away from the obstacle or reverses direction, braking is automatically interrupted. This function reduces strain on the driver in difficult-to-monitor driving environments for improved safety and convenience. Just like any other BMW assistance system, this research application can also be overridden by the driver at any time.”

### D. Self-Driving Vehicles Regulated by Collision Avoidance Systems that May be Used in Combination with the Present Invention

Scientific American provides a summary of the combination of self-driving vehicles and collision avoidance systems:

“In the world of self-driving cars, all eyes are on Google. But major automakers are making moves toward autonomous driving, too. Although their advanced-safety and driver-assistance features may seem incremental in comparison, many are proofs of concept for technologies that could one day control driverless cars. At the same time, the National Highway Traffic Safety Administration (NHTSA), the arm of the Department of Transportation charged with establishing and enforcing car-safety standards and regulations, is studying and testing the road readiness of these control and machine-vision systems. In the short term, as buyers hold their breath for robotic cars, making automation features standard will save lives.”

“In January of 2015, the NHTSA announced that it would begin to factor crash-preventing braking systems into its car-safety ratings. The systems use forward-facing sensors-which can be radar-, camera- or laser-based-to detect imminent collisions and either apply or increase braking force to compensate for slow or insufficient driver reactions. Honda was first to introduce such a system in 2003; since then, nearly every automaker has rolled out similar features on high- and mid-range models.”

“Every new car sold after May 1, 2018, must have a backup camera, per a safety regulation issued by the NHTSA in 2014. The rear-facing cameras, available now on dozens of models, provide drivers with a full rear field of view and help to detect obstacles in blind spots. The NHTSA estimates that improving visibility in this way could save 69 lives every year.”

“For self-driving cars to navigate roads en masse, each must have the position, speed and trajectory of nearby automobiles. Last summer the NHTSA announced that it would explore how to standardize such vehicle-to-vehicle communication. The feature could improve coordination for human and machine alike during accident-prone maneuvers, such as left-hand turns.”

“In 2013 the NHTSA established how to test the effectiveness of camera systems that watch existing painted lane markers and alert drivers if they drift. Some cars, such as the Toyota Prius, now even take over steering if a driver does not respond quickly enough to warning signals. And new 2015 models from Mercedes-Benz and Volkswagen go further, using cameras and sensors to monitor surroundings and autonomously steer, change lanes and swerve to avoid accidents.”

### E. Sensors for Fully Autonomous Cars that May be Used in Combination with the Present Invention

Automotive News reports on sensors for fully autonomous cars:

“The sensors needed for collision avoidance—radar, cameras, ultrasound and lidar—have become a big business already.”

“Global sales of anti-crash sensors will total $9.90 billion in 2020—up from $3.94 billion this year, predicts IHS Automotive, a research firm based in suburban Detroit.”

“Radar and cameras will account for the lion's share of that revenue, followed by ultrasound and lidar, according to the IHS forecast.”

“Lidar, the sensor of choice used on Google's driverless car, will generate relatively small sales by 2020. It uses pulsed laser light to measure distances.”

“Within a decade or so, say industry analysts, the array of collision-avoidance sensors will feed data to powerful onboard computers to create self-driving vehicles. Some planners also believe that safe autonomous driving also will require vehicle-to-vehicle communication enabled by wireless devices called transponders.”

“Some suppliers are developing lidar sensors to back up radar and cameras for fail-safe lane changes.”

“Each type of sensor has its strengths and weaknesses. Inexpensive ultrasound sensors are good at detecting obstacles at short distances, which makes them useful for assisted parking.”

“Radar can accurately determine the distance and location of an obstacle in the road . . . but is not very good at identifying a cyclist, pedestrian or animal. Cameras, by contrast, are very useful for identifying the type of obstacle, but they have a shorter range than radar.”

“Cameras can be affected by rain and dirt, while radar can be impaired by dense fog . . . but they are generally not susceptible to the same conditions, which is why they are so frequently paired in sensor fusion systems.”

“A lidar sensor has a wide field of view and delivers a very detailed image. Google and Nokia's HERE unit both use lidar to map roads, but that type of lidar is too bulky and expensive for production cars.”

### F. An Autonomous Vehicle Test System that May be Used in Combination with the Present Invention

An article entitled The Future of Autonomous Systems, published in Inside Unmanned Systems, describes an Autonomous Vehicle Test System:

“THE AVTS consists of four key elements—the Test Vehicle Drop-In Actuator Kit (DAK), target robots, AVTS software and a positioning system provided by Locata.”

“Using robotics for testing is more efficient because the IIHS staff will be able to know, without a doubt, that each test is performed in the exactly the same way, every time . . . ”

“The main goal is to enable us to carry out repeatable and precise tests of the crash avoidance technology that's in the cars we drive . . . ”

“The AVTS was developed based on requirements from the Institute for Highway Safety.”

“The DAK, one of two robotic platforms that make up the AVTS, can be installed in any car in 30 minutes or less . . . . The kit attaches to the steering wheel, brake and throttle and allows the test driver to sit in the passenger seat as the robot steers the car.”

“The DAK ties into a box that can be stored in the trunk, back seat or passenger seat, he said. That box houses the electronics that provide the data from various sensors, including speed sensors, the Locata positioning system as well as a heading sensor that lets testers know where the vehicle is so it can navigate according to a pre-defined path or a sequence of maneuvers.”

“The second robot is basically a dummy car . . . or balloon car that test vehicles can crash into without sustaining damage. This target robot is a mobile platform that carries a soft, crashable target and presents itself to the test vehicle as another automobile.”

“This dummy car can support collisions of up to 55 mph and if the test car and target robot collide, the test vehicle simply bumps into the soft target and drives over the robotic platform.”

“Perrone Robotics first began developing the software used in the AVTS in 2001, Perrone said, with the goal of creating a general purpose software platform for mobile robotics. They put that software to the test in 2005 when they entered the DARPA Grand Challenge, which tasked teams with building a self-driving ground vehicle able to travel across the Mojave Desert.”

“Perrone continued to hone its software, entering a second DARPA challenge in 2007. This time they had to develop a self-driving vehicle that could navigate an urban setting and do everything a human would do including avoiding other vehicles and stopping at intersections.”

“The AVTS software is an extension of those projects . . . and contains the same DNA and the same capabilities to perform just about any maneuver necessary with high precision. The software defines and controls the tests, as well as transfers and reviews data. Each target robot and DAK includes an embedded computer that runs the software for autonomous self-navigation and bot-to-bot communication for precise coordination of relative positioning and logging data.”

“To successfully test current and future collision avoidance technology, IIHS needs to be able to achieve very accurate measurements of each vehicles' position on the test track, as well as the vehicles' positions relative to one another. Instead of relying on GPS for positioning, which can be obstructed by trees and impacted by other factors like jammers . . . [IIHS used] Locata, an independent, ground based positioning system that offers precise, reliable, local positioning.”

“[In the] first public demonstration of the system . . . the Locata installation achieved 4 cm precision accuracy during the demonstration . . . in both the vehicle under test and the collision target robot.”

“Even though the AVTS isn't quite finished, IIHS has already begun using the Locata system and the target robot to test and rate front crash prevention systems. These systems give warnings when a car is about to crash, and automatically apply the brake if the driver doesn't respond fast enough.”

“Self-driving cars are equipped with sophisticated safety systems that consist of sensors, radars, cameras and on-board computers, which makes them capable of avoiding obstacles and collisions with other vehicles, pedestrians or cyclists . . . ”

“With autonomous cars, risky driving behaviors, such as speeding, running red lights, driving under the influence, or aggressive driving, could well become a thing of the past. These systems also can reduce traffic congestion, cut carbon emissions, improve traffic flow and even improve air quality . . . ”

### G. Traffic Collision Avoidance Systems that May be Used in Combination with the Present Invention

Wikipedia reports that Traffic Collision Avoidance Systems (TCAS) are already in use in civilian aircraft:

“A traffic collision avoidance system or traffic alert and collision avoidance system . . . is an aircraft collision avoidance system designed to reduce the incidence of mid-air collisions between aircraft. It monitors the airspace around an aircraft for other aircraft equipped with a corresponding active transponder, independent of air traffic control, and warns pilots of the presence of other transponder-equipped aircraft which may present a threat of mid-air collision (MAC). It is a type of airborne collision avoidance system mandated by the International Civil Aviation Organization to be fitted to all aircraft with a maximum take-off mass (MTOM) of over 5,700 kg (12,600 lb) or authorized to carry more than 19 passengers. CFR 14, Ch I, part 135 requires that TCAS I is installed for aircraft with 10-30 passengers and TCAS II for aircraft with more than 30 passengers.”

“ACAS/TCAS is based on secondary surveillance radar (SSR) transponder signals, but operates independently of ground-based equipment to provide advice to the pilot on potential conflicting aircraft.”

“In modern glass cockpit aircraft, the TCAS display may be integrated in the Navigation Display (ND) or Electronic Horizontal Situation Indicator (EHSI); in older glass cockpit aircraft and those with mechanical instrumentation, such an integrated TCAS display may replace the mechanical Vertical Speed Indicator (which indicates the rate with which the aircraft is descending or climbing).”

### VI. Another Alternative Embodiment of the Invention

FIG. 22 shows a vehicle 12 which is equipped with one particular embodiment of the present invention. Two telescopes 174 are mounted on the roof of the vehicle 12. They emit LIDAR beams 176 that illuminate various objects around the vehicle: pedestrians P, a rider on a bicycle B, and another vehicle A which is not equipped with the present invention. Each object or target is illuminated by more than one beam. In this depiction, each target is illuminated by two beams.

In this Specification, any vehicle which is equipped with the present invention is identified by reference character 12, while vehicles or objects that do not have capabilities offered by the present invention are identified with capital letter reference characters.

The scene depicted in FIG. 22 does not receive signals from a satellite, S. For this reason, navigation, location and guidance systems are unable to rely on the Global Positioning Satellite System.

The alternative embodiment of the invention that is employed in vehicle 12 in FIG. 22 provides an improved Area Range and Velocity Sensor 46 which furnishes enhanced situational awareness by using more than one telescope 174 to emit more than one beam 176. This alternative embodiment is mass producible and affordable for automotive markets.

The telescopes 174 scan the environment around the vehicle 12 continuously. When a beam 176 hits something, it bounces back and its frequency change is used to compute the speed along the line of sight (radial velocity), as well as the range along the line of sight (radial distance). Making this measurement of the same object with two telescopes 176 that are offset from one another provides enough data for the algorithm used by the present invention to calculate the absolute velocity (in an arbitrary reference frame, e.g., East-West-North-South). This gives the Area Range and Velocity Sensor 46, and, therefore, the pilot or vehicle control system, the trajectory of each item in its local environment and allows it to navigate to meet its goals.

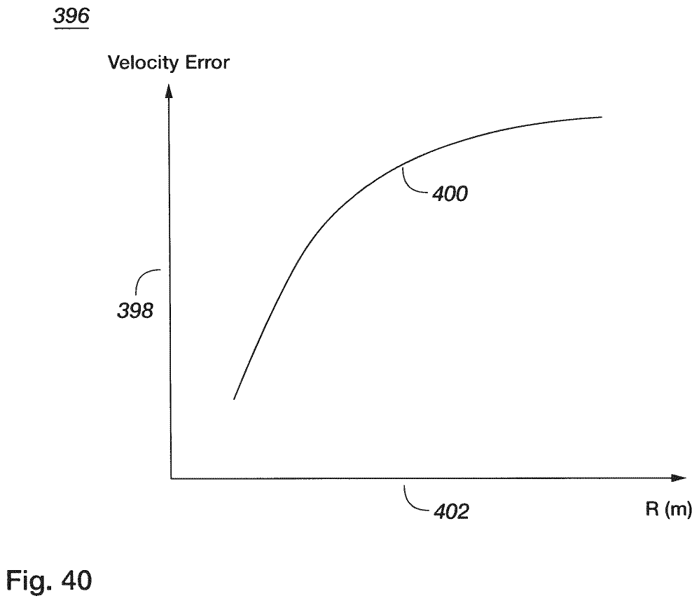

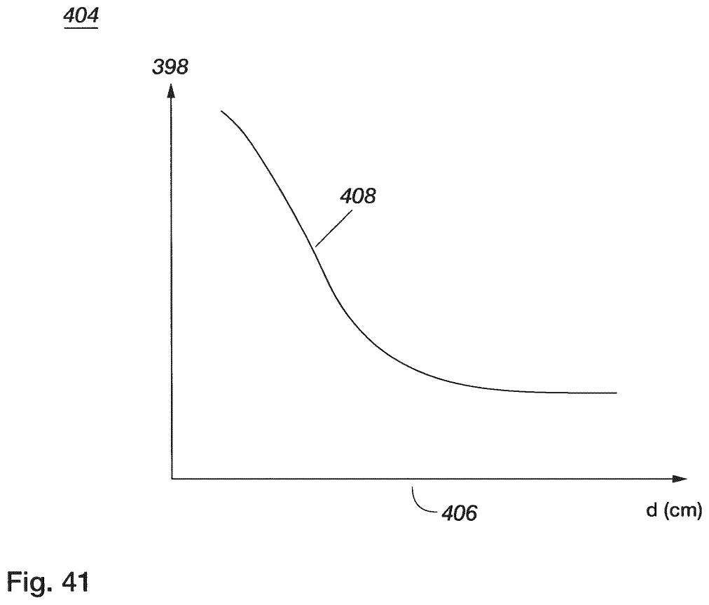

FIG. 22A supplies an enlarged view of FIG. 22, showing just the vehicle 12 and the pair of telescopes 174. In one particular embodiment of the invention, the distance 175 between the pair of telescopes 174 is optimized to enhance the performance of the present invention. See FIGS. 40-43, and text which describes them, which follow in this Specification, for a description of the optimized distance between the telescopes 174. The beam separation distance is the independent variable in FIG. 41. The total error is a function of many different variables, so each plot shown assumes most of them are determined, and the one independent variable shown is changing to affect the total error. The optimal separation distance is a function of the total allowable error, so it is also a function of many different variables.

One embodiment of the present invention requires that the telescopes 174 be separated by an optimized distance 175. In addition, in this embodiment, each telescope 174 simultaneously illuminates the same general point on the same target.

In this embodiment, two or more independent beams that are coordinated in pointing and whose measurements are co-processed to provide relative navigation state parameters (distance, speed, and direction) in a GPS-denied environment. This configuration provides improved situational awareness of environmental obstacles and other vehicles.

The separated telescopes allow the computation of relative velocity and other parameters with respect to the telescopes. This separation is critical for safe autonomy, because it provides a predicted trajectory of environmental hazards that allows a safe path to be planned.

In one embodiment of the invention, more than one telescope in the Area Range and Velocity Sensor is used to not only measure range and velocity along the line of sight of the Area Range and Velocity Sensor, but to use it to develop a parallax view that constrains the equations of motion of the target enough to determine the target's speed and direction of travel in any coordinate frame. This feature is critical for weapons targeting.

For example, if a pedestrian is walking her bike across a dark street at night. The present invention specifies her distance, speed and direction of travel from the telescopes, and predicts where she will be in the future so that a car equipped with the present invention is able to avoid hitting her.

In one embodiment of the invention, both beams are registered relative to one another, and relative to another sensor like the Navigation Reference Sensor. A set of algorithms are utilized to process information received from the reflected beams. The various components of apparatus of the invention, such as the waveform generator (laser/modulation integration), detector receiver (photonic and/or electronic integration), and the FPGA/ASIC processor, are designed to be mass producible.

In one embodiment of the present invention, the ARVS has dynamically pointed telescopes. These are used to measure the movement of an object or vehicle external to the telescope. The optical axes and the relative location of the telescopes define a measurement reference. The area sensor measures the movement of that reference relative to the target, hence the steps on the already submitted algorithm to affect coordinate transformations back to the center of mass of the vehicle carrying the sensor. The present invention works with two or more telescopes, depending on the number of degrees of freedom of the telescopes, and the external objects or vehicles.

The present invention is used to calculate the speed and direction of an external body in an absolute sense by combining the area sensor data with the navigation reference sensor measurement to determine absolute position as described above.

In one embodiment of the invention, the further away the target is the more separation is needed. In the limit, it is linear. The optimal separation is a function of the following: distance to target, speed of target, direction of travel of target, the SNR of the measurement and the allowable error. General relationships between these are shown in FIGS. 40, 41, 42 and 43.

In one embodiment, one telescope 174 illuminates a target with a single beam. Two or more separated telescopes receive the reflections. Information is obtained when a target is illuminated with one telescope: velocity and range along the optical axis of the telescope. In order to get speed and the absolute direction of travel of the target, more than one transceiver is required, and they need to be separated in space.

The present invention works the same way whether the sensor is stationary or moving and whether the target is stationary or moving.

One objective of this alternate embodiment is to gather two independent pieces of information in a two dimensional situation and three independent pieces of information in a three dimensional situation. Each telescope measures the speed along the direction of the beam. The actual velocity in a two dimensional plane requires two measurements.

One objective of the present invention is to gather two independent pieces of information. Each device measures the speed along the direction of the beam. The actual velocity in a two dimensional plane requires two measurements.

The telescope is an optical device that has a relatively narrow field of view and provides an image of a distant object. Many telescopes that may be used to implement the present invention are available in the commercial marketplace. See websites for: princetel, edmundoptics, and ozoptics.

One important benefit provided by the “parallax” AVRS 166 is the reduction the error in the measurement of velocity and range. Many variables affect this measurement. One of those variables is the separation of the telescopes.

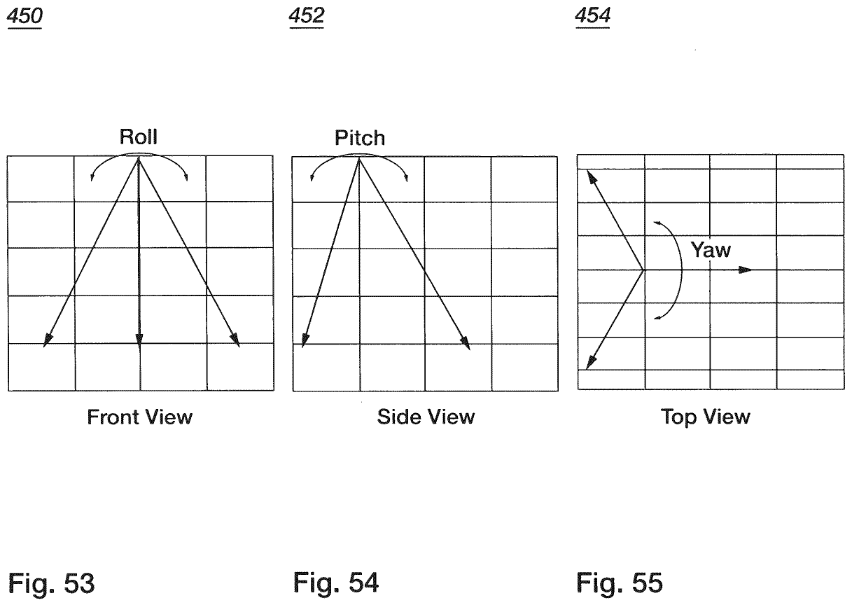

Other important variables affecting error are the angle of travel of the target with respect to the telescope 174 and the speed of the target with respect to the telescope 174. For a given separation, the range to the target affects the error. These measurements are shown in the plots in FIGS. 53, 54 and 55.

In general, the farther away the target, the wider the separation needs to be to ensure low errors. However, the sensitivity or SNR of the receiver also plays a role. If the SNR is very high, then the dependence of error on range is not significant. That is why the plot of error versus range flattens out. So, increasing the separation of the telescopes reduces error in many cases because the sensor SNR is set at the design and manufacturing stage.

In one embodiment of the invention, one lens is employed. In another embodiment, two lenses are used. In another, one or more mirrors are used. In another embodiment both lenses and mirrors are used. These lenses and mirrors are available in the commercial marketplace.

In this embodiment of the invention, the optimized distance 175 between the telescopes 174 makes it easier it is to measure cross track velocities. This distance 175 also enables the steering or pointing of the optical axis. The relative attitudes or optical axes of the telescopes 174 must be very well known so, in this embodiment, they are mounted in a single structure.

The separation distance between telescopes 174 is used to determine the arbitrary velocity vector of a target is a function of many factors. For example, the distance to the target, the signal-to-noise ration (SNR) of the measurement in the frequency domain, the speed of the target and the angle of the target's trajectory with respect to the telescope's trajectory all affect the error in the final velocity vector measurement. However, there are some quantitative measures that can be used for design purposes for certain situations.

In one embodiment, for slower moving (<65 kph) targets, and when using a system with SNR of at least ten, the separation distance is equal to or greater than 1/75th of the range to the target. Thus for a target at a range of one hundred meters, the separation distance should be at least 1.33 meters. In general, for faster moving targets, lower error measurements are possible. In this case, the ratio of range to separation distance can be increased by a factor of four, to three hundred, for faster moving (>250 kph) targets. These design goals provide fast, high-fidelity measurements (single measurements correct more than 95% of the time). When less critical measurements are an option they can be relaxed and still allow determination of target vector velocity.

Measurements for a given range and target speed are generally more difficult to obtain when the target is moving nearly perpendicular to the beam pointing direction. This provides some additional design direction. In this alternative, the telescopes 174 are mounted and separated, so that for any possible target motion at least one telescope 174 will have a non-perpendicular line of sight to the target.

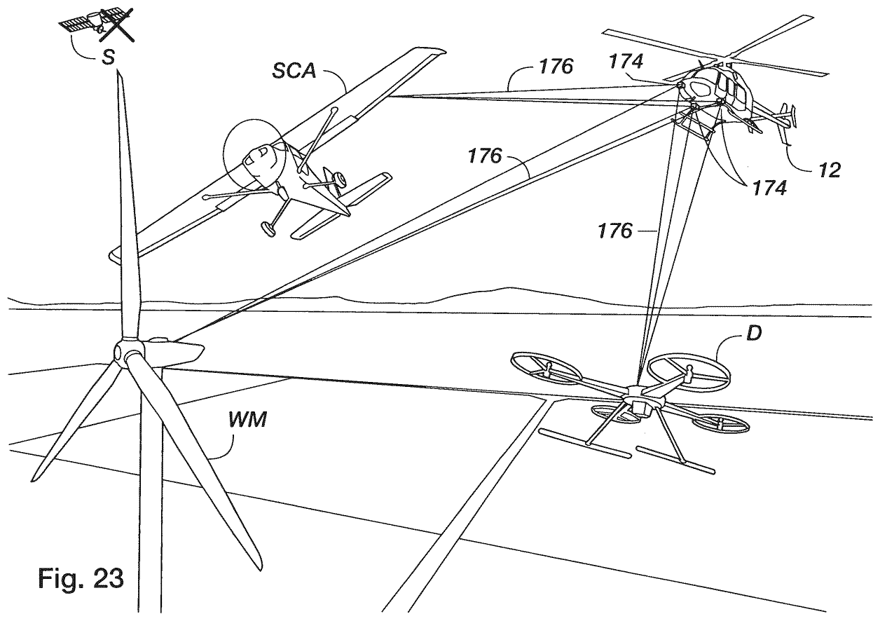

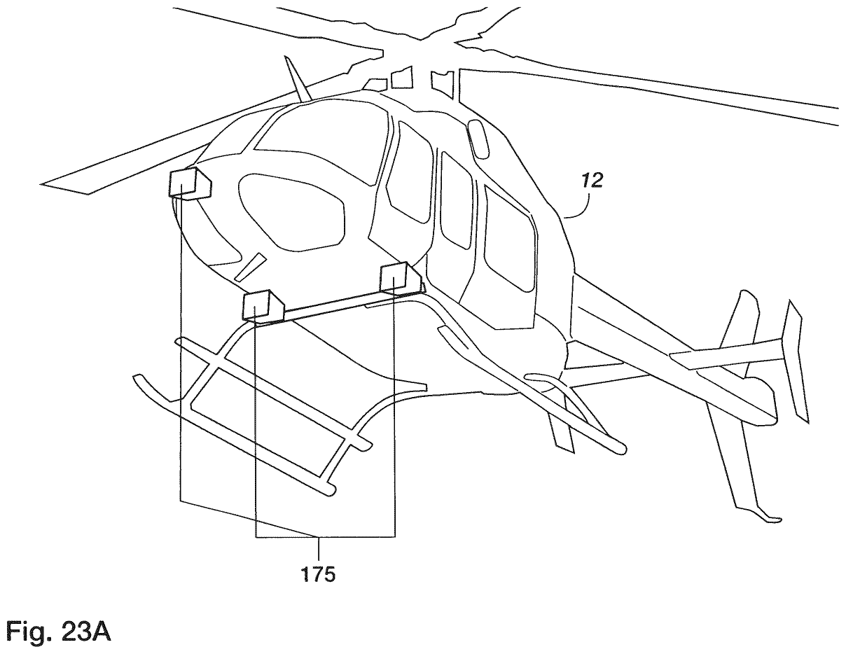

FIG. 23 provides a view of a helicopter 12 which is equipped with optimally separated telescopes 174, and which is operating in a GPS-denied environment. Telescopes 174 emit beams 176 which illuminate a small commercial aircraft SCA, a drone D, and a windmill WM.

FIG. 23A offers a more detailed and magnified view of the helicopter 12 shown in FIG. 23, and which shows the optimized separation distance 175 of the telescopes 174.

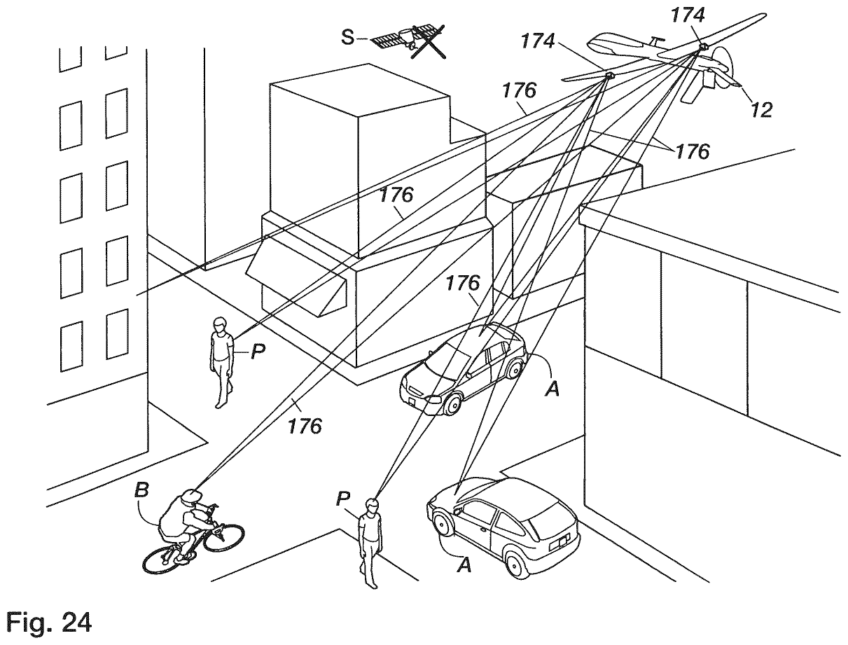

FIG. 24 supplies a view of a drone 12 which is equipped with the present invention, and which operates in a GPS-denied environment. Telescopes 174 emit beams 176 which illuminate a variety of targets, which include autos A, pedestrians P, and a bicyclist B.

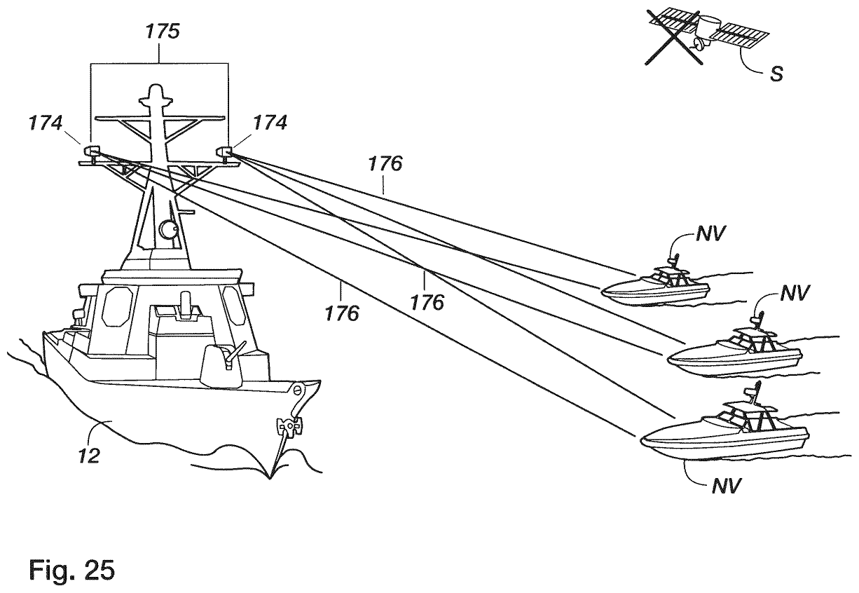

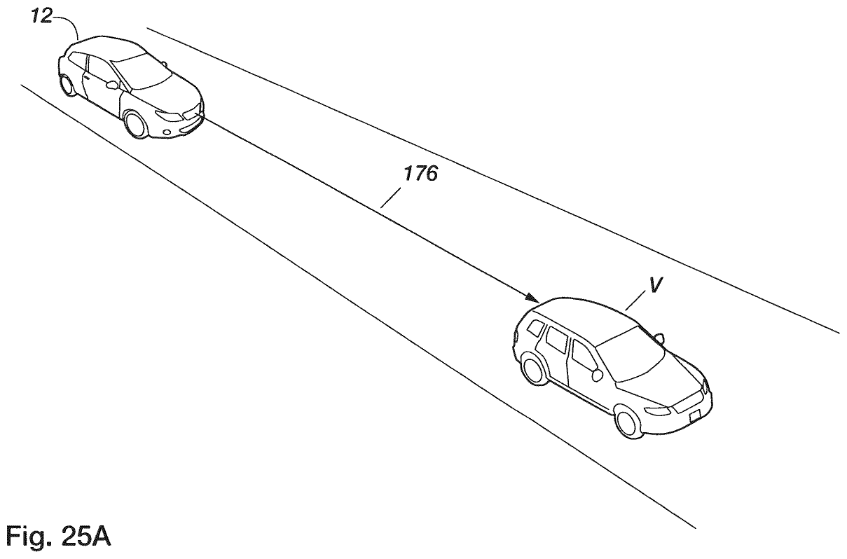

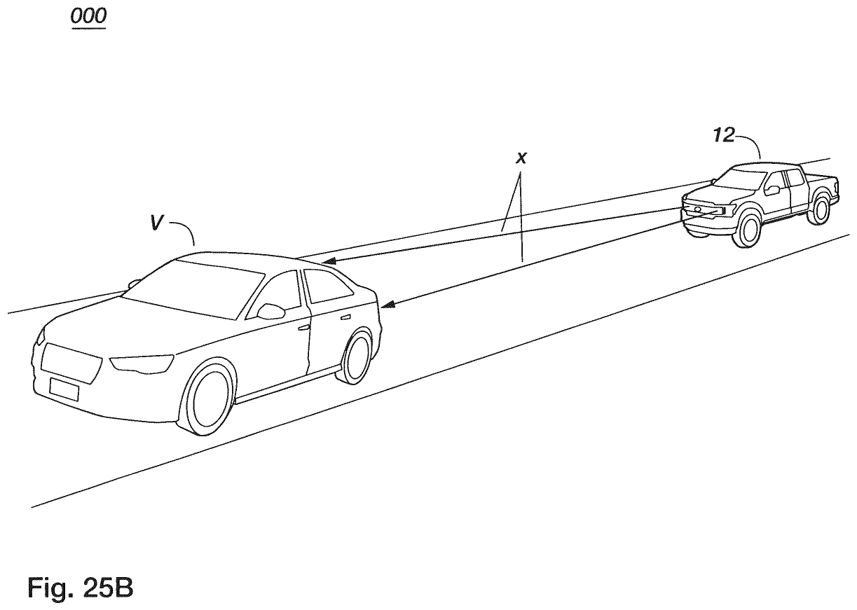

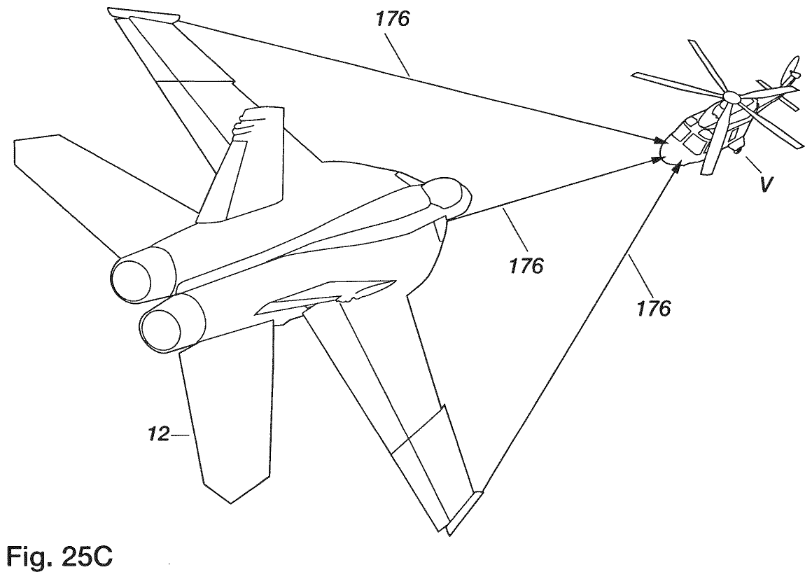

FIG. 25 furnishes a view of a naval vehicle 12 that operates in a GPS-denied environment, and that is equipped with the present invention. The telescopes 174 emit beams 176 which shine on naval vehicles NV, and their distance, speed and direction are measured.

FIG. 25A depicts a vehicle 12 which is equipped with the present invention, and another vehicle V, both of which are traveling down a road. Vehicle V is illuminated by a beam 176.

FIG. 25B shows two vehicles 12 and V. Vehicle 12 emits beams 176 that shine on vehicle V.

FIG. 25C shows a military aircraft 12 which is equipped with the present invention, and a helicopter V. The jet 12 emits beams 176 toward the target V.

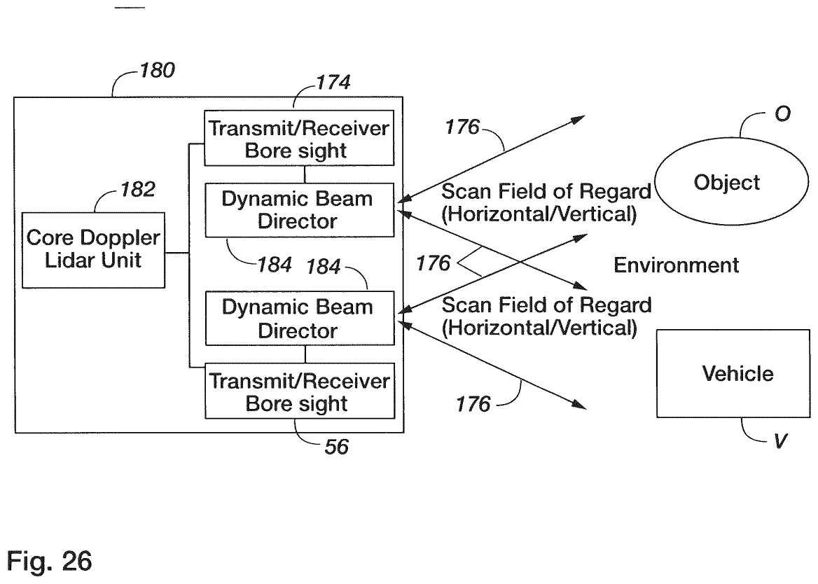

FIG. 26 is a schematic diagram 178 which reveals one embodiment of circuitry that may be used to implement the present invention. An Dynamic Area Range and Velocity Sensor 180 includes a Core Doppler LIDAR Unit 182, which is connected to a pair of telescopes 174 and to a pair of Dynamic Beam Directors 184. Each Dynamic Beam Director 184 emits beams 176 which scan the field of regard, in both the horizontal and vertical dimensions. The beams 176 illuminate objects O and vehicles V. FIG. 26 shows two dynamic beam directors with overlapping fields of regard in the instrument that are separated.

The boresight function can be accomplished in more than one way. For example, a telescope aligns the outgoing and incoming beam. This is called monostatic. An alternative embodiment employs two telescopes for one beam. One sends the beam out, and one collects the return. This is called bistatic.

The beam may be transmitted with one optic and receive signals with one or more telescopes. In each case, it is necessary to align the outgoing beam to the incoming beam. This is called boresighting.

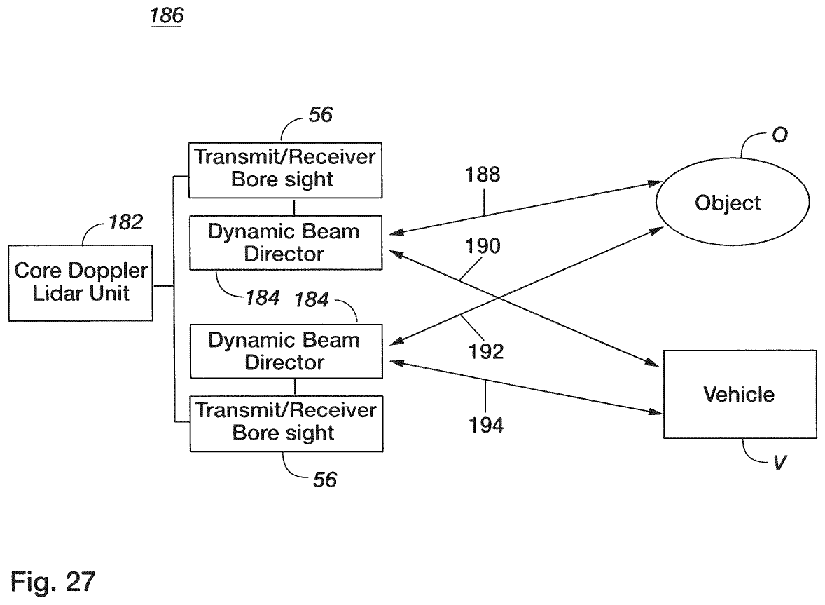

FIG. 27 is a schematic diagram 186 that shows that the first Dynamic Beam Director 184 transmits beams 188 and 190, while the second Dynamic Beam Director 184 transmits beams 192 and 194. FIG. 27 illustrates how one beam from each telescope 174 must hit the target object O or vehicle V in order to determine velocity in an arbitrary reference frame.

The modulation of the lasers can be accomplished by an external modulator or internally by modulating lasers directly through its pump current or by changing the length of the laser cavities.

The high degree of coherence obtained by the Narrow Linewidth Emitter 64 and Local Oscillator 70 prevent stray light or external emitter electromagnetic radiation to be detected by the Receiver 74. This unique capability enables high signal-to-noise detection even in very high traffic electromagnetic environments.

The modulator creates a spectrally pure, modulated carrier frequency that has an identically (1 part in 103) linear frequency increase as a function of time, from which distance measurements are made entirely in the frequency domain.

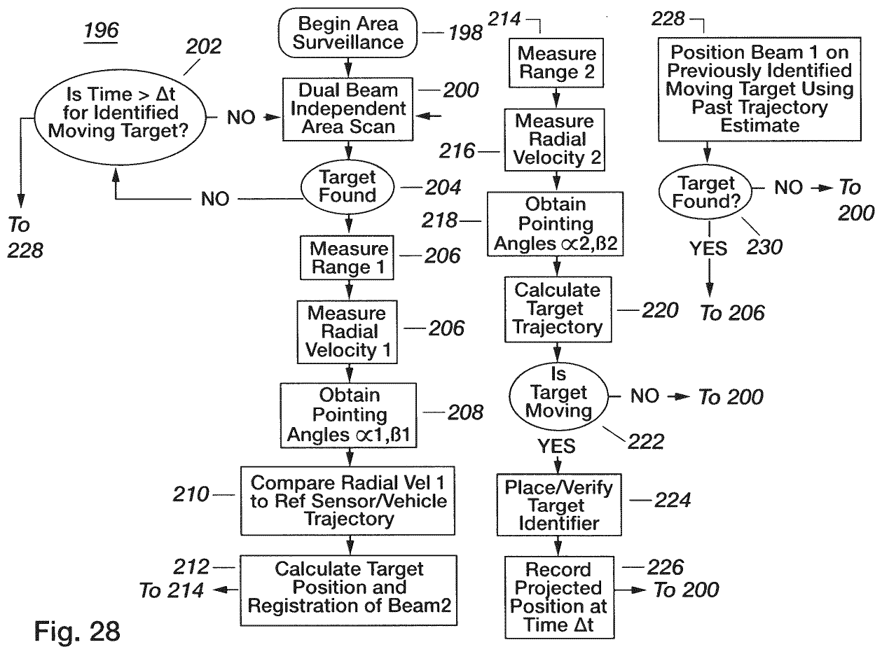

FIG. 28 is a flow chart 196 which illustrates one particular set of operation steps that are used as instructions for circuitry that may be used to implement one embodiment of the present invention. The present invention registers the beams, meaning that two beams are focused on the same target.

The following table describes each operation step:

TABLE ONE

| | |
|---|---|
| 198 | Begin area surveillance |
| 200 | Dual beam independent area scan |
| 202 | Determine if current time is greater than Δt for an identified |
| | moving target |
| 204 | Determine if target is found |
| 206 | Measure Range 1 & radial velocity |
| 208 | Obtain pointing angles al and β1 |
| 210 | Compare radial velocity 1 to reference sensor/vehicle trajectory |
| 212 | Calculate target position and registration of beam 2 |
| 214 | Measure range 2 |
| 216 | Measure radial velocity 2 |
| 218 | Obtain pointing angels |
| 220 | Calculate target trajectory |
| 222 | Determine if target is moving |
| 224 | Place/verify target identifier |
| 226 | Record projected position at time Δt |
| 228 | Position beam 1 on previously identified moving target using past |
| | trajectory estimate |
| 230 | Determine if target has been found |

The value Δt is the time it takes to make both measurements of a single target. This time delay value is used to make the algorithm that accomplishes the signal processing operate efficiently. The value a1 is the horizontal pointing angle for Measurement 1 (188 in FIG. 27), β1 is the vertical angle for Measurement 1; α2 is the horizontal pointing angle for Measurement 2, and β2 is the vertical angle for Measurement 2 (192 on FIG. 27).

Measurement 1 for the Vehicle is shown as 190, and Measurement 2 is identified as 194, the Vehicle. Each of those would have an α1 and a β1; and an α2 and a β2.

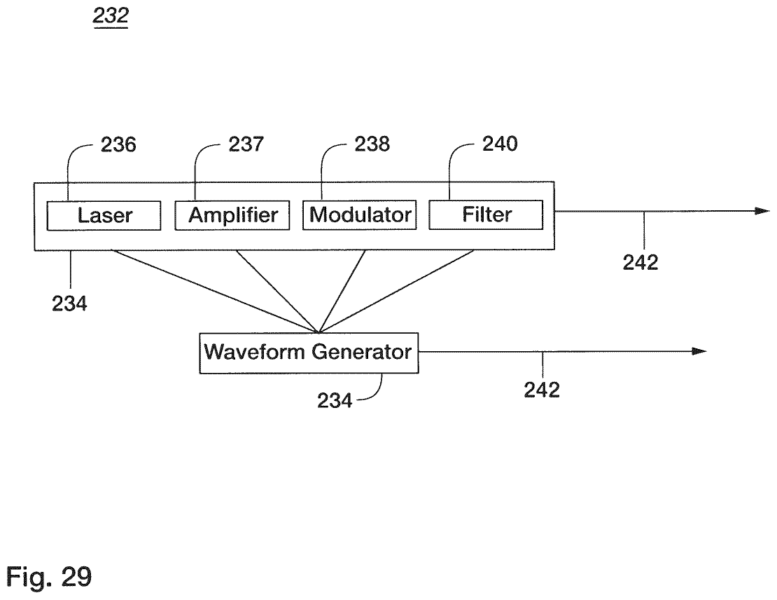

FIG. 29 is a schematic diagram 232 of one embodiment of mass-producible circuitry that may be used to implement the present invention. FIG. 29 shows how electro-optical components are combined into a single device that can be built in mass quantities. A waveform generator 234 includes a laser 236, an amplifier 237, a modulator 238 and a filter 240, which provides an output 242.

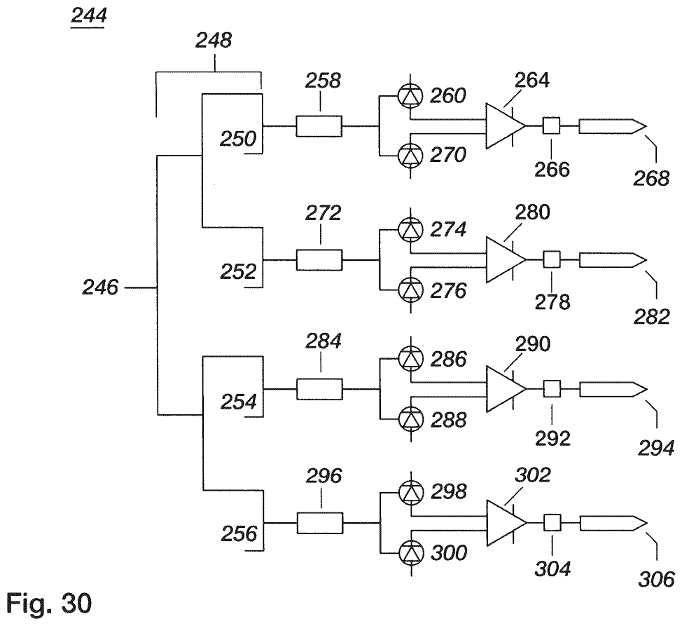

FIG. 30 offers another schematic diagram 246 of circuitry that is employed to implement one particular embodiment of the present invention. FIG. 30 shows how waveguides are combined with detection devices and amplifiers into a single device that is mass manufacturable.

FIG. 30 is a view 246 of four identical portions of a circuit. Each portion is connected to a telescope 174. An input from a local oscillator 248 is fed to four switches 250, 252, 254, and 256. The output of each switch is fed to an optical waveguide 258, 272, 284 and 296. The output of each optical waveguide is conveyed to a pair of diodes: 260 & 270; 274 & 276; 286 & 288 and 298 & 300. Each diode has an output to an amplifier: 264, 280, 290 and 302. The output of each amplifier is provided to an anti-aliasing filter: 266, 278, 292 and 304. Finally, the output of each anti-aliasing filter is conveyed to an analog-to-digital converter: 268, 282, 294 and 306.

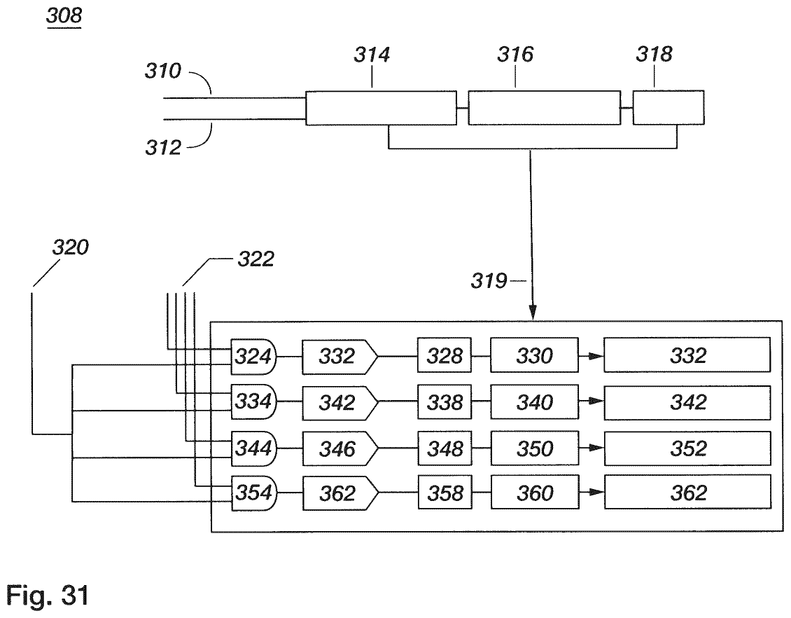

FIG. 31 is a schematic diagram 308 which shows an alternative combination that includes multiple components which are incorporated into a single device that may be built in large numbers. A signal from the receiver 310 and an input from the local oscillator 312 are conveyed to a photodetector 314, which, in turn, is fed to an analog-to-digital converter 316, and then to a field programmable gate array 318.

All of these are incorporated into a single device with multiple channels shown as 319. The Local Oscillator 320 and multiple input signals are fed to four photodetectors 324, 334, 344 and 354. The outputs of the photodetectors are fed to analog-to-digital converters 332, 342, 346 and 362. The outputs of the analog-to-digital converters are conveyed to Fast Fourier Transfer circuits 328, 338, 348, 358. The output of the FFT chips 328, 338, 348, and 358 are supplied to filtering components 330, 340, 350, and 360. The outputs of the filtering components are fed to post processing circuits 332, 342, 352, and 362.

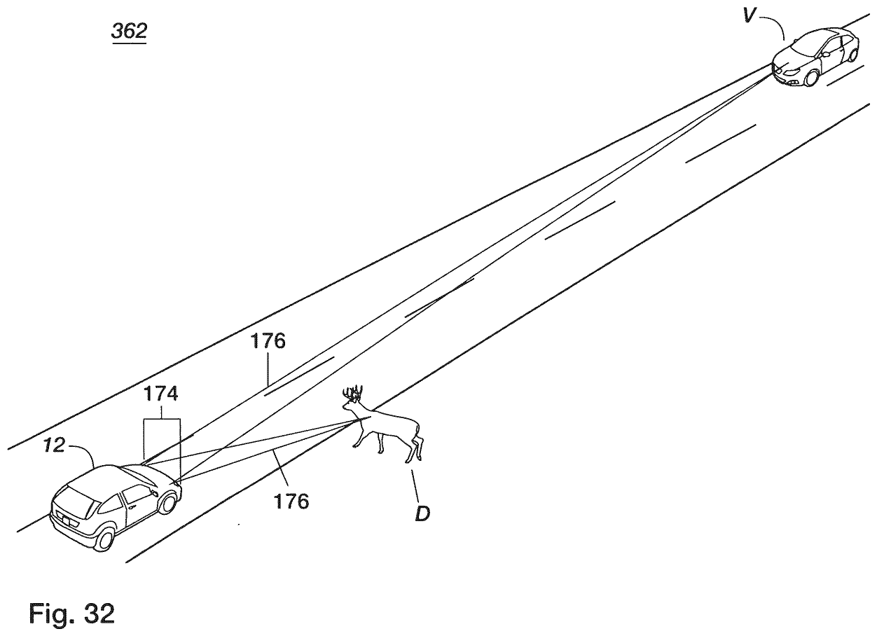

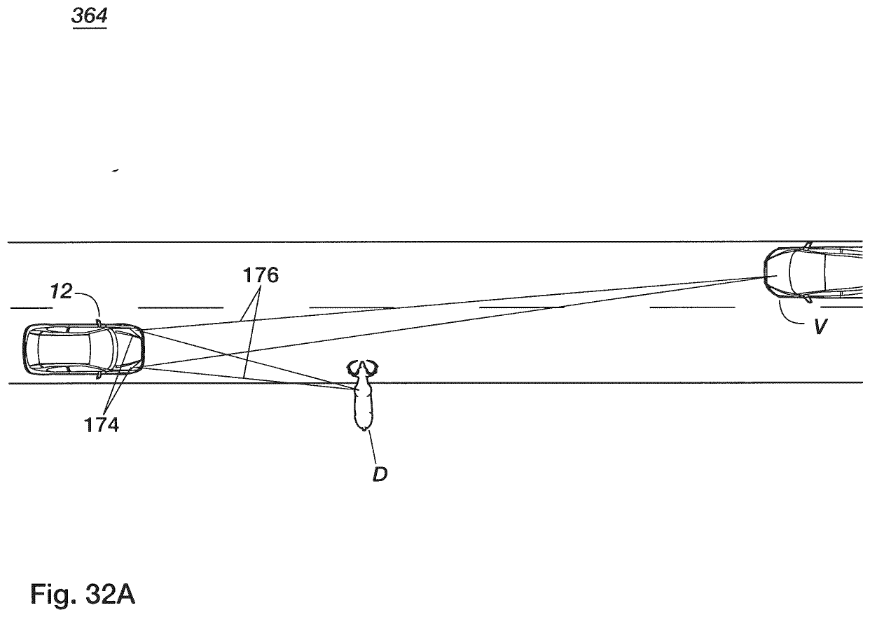

FIG. 32 is a view 362 which depicts two targets in the field of regard whose range, speed and direction are determined to allow the sensing vehicle 12 to navigate without a collision. A car 12, which is equipped with the present invention, has two telescopes 174 which emit beams 176 that illuminate another car V and a deer D.

FIG. 32A is another view 364 of the scene depicted in FIG. 32, but which occurs at a time later than the scene shown in FIG. 32. FIG. 32A shows the vehicle 12 with telescopes 174 going around first object with knowledge of range to the second object, the deer D.

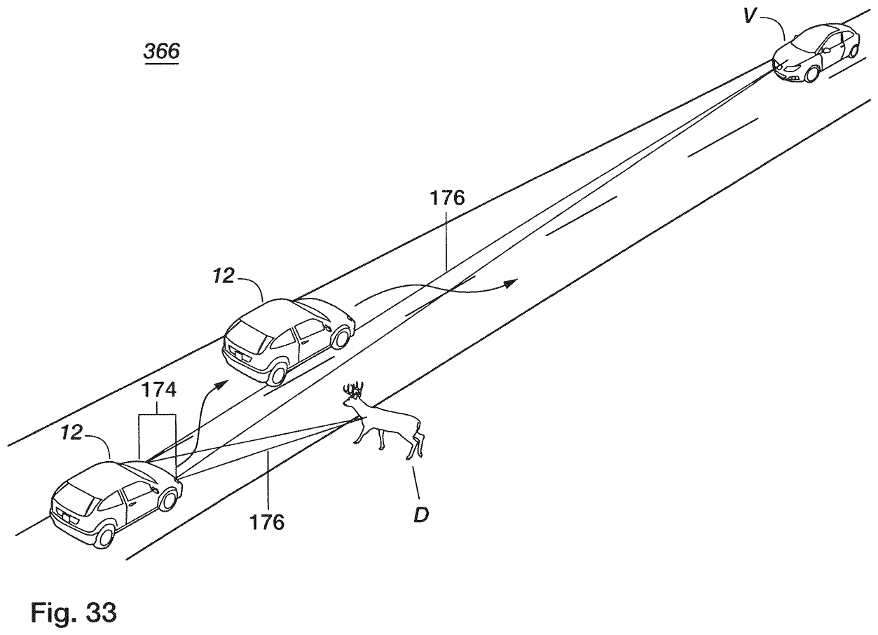

FIG. 33 is another view 366 of the scene shown in FIG. 32A. The scene illustrated in FIG. 33 occurs at a time that is later than the time of the scene shown in FIG. 32A. The vehicle 12 is shown in a first position on the road, and then is shown in a second position after changing direction to avoid the deer D.

FIG. 33A is an overhead view 368 of the scene shown in FIG. 33.

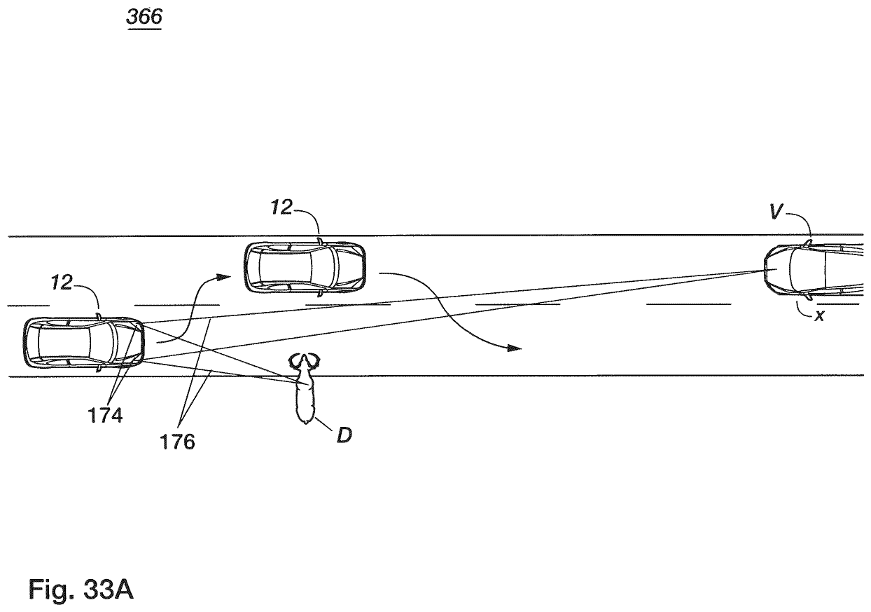

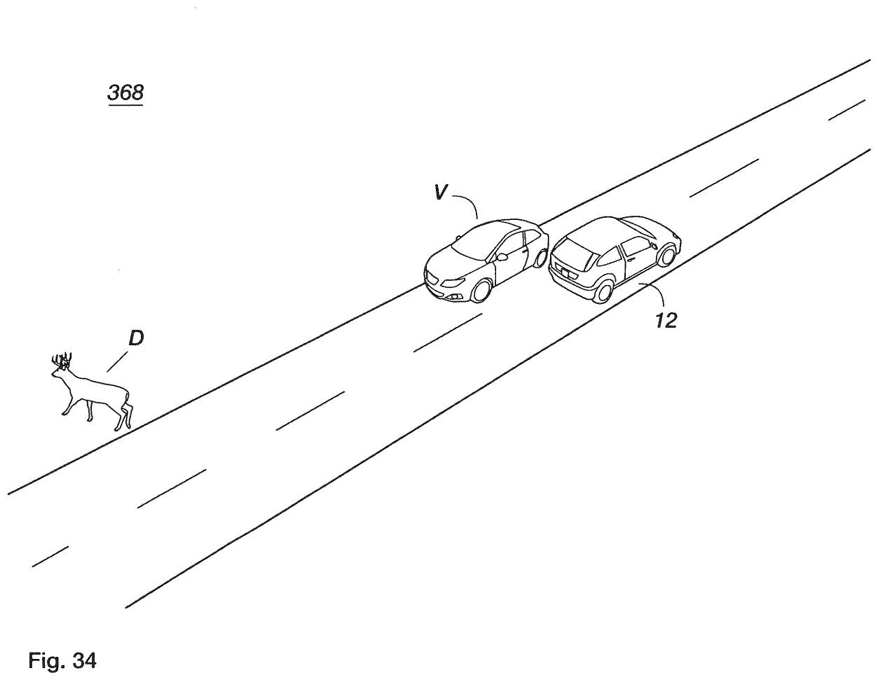

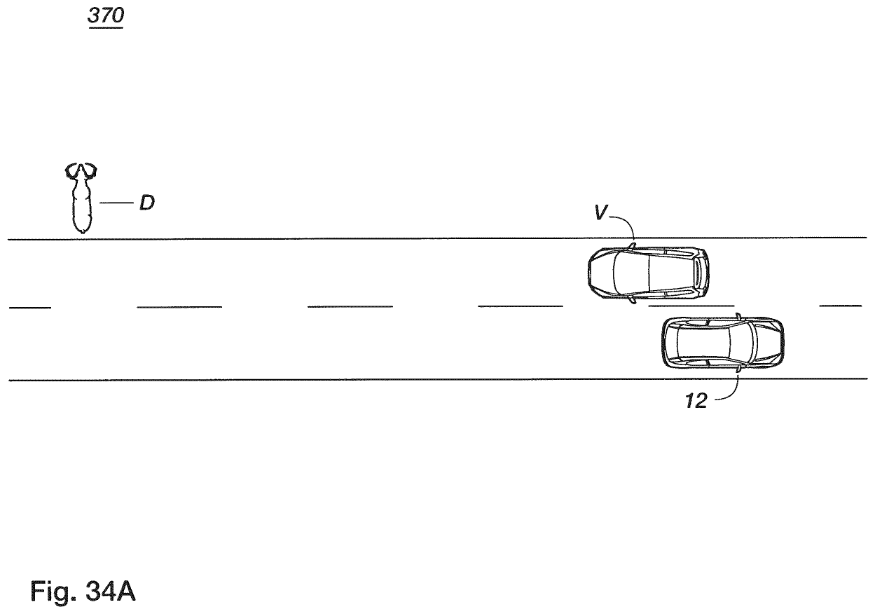

FIG. 34 presents a view 369 that shows the car with sensors 12 safely passing the oncoming car after avoiding the deer D.

FIG. 34A is an overhead view 370 of the vehicles shown in FIG. 34, shown at a time after the vehicle 12 has avoided any collision.

### VII. Implementation of the Invention

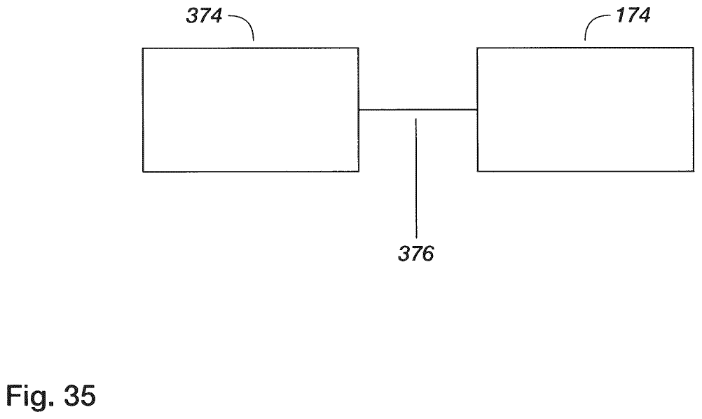

FIG. 35 is a schematic diagram of a Navigation Sensor System 372, which includes a core unit 374 and optical fiber 376 and a telescope 174.

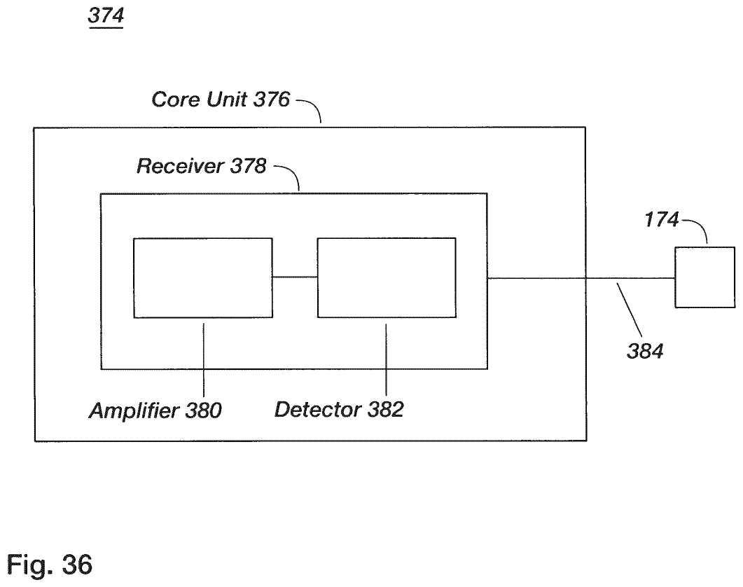

FIG. 36 supplies a view 374 of a Core Unit 376. The Core Unit 376 includes a Receiver 378, which includes an Amplifier 380 connected to a Detector 382. The Detector 382 is connected to an optical fiber 384, which is connected to a telescope 174.

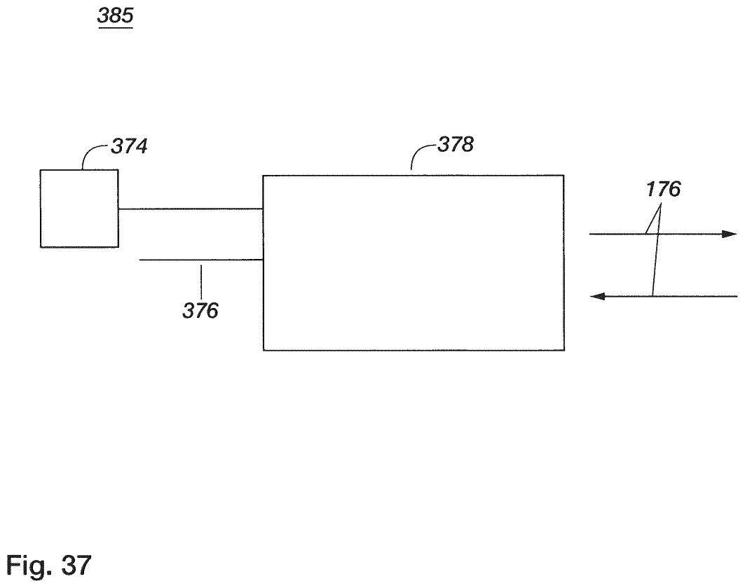

FIG. 37 is a schematic diagram of a transceiver 385 with outgoing and incoming light beams 176. The Core Unit 374 is shown connected to the transceiver 378 optical fiber 376.

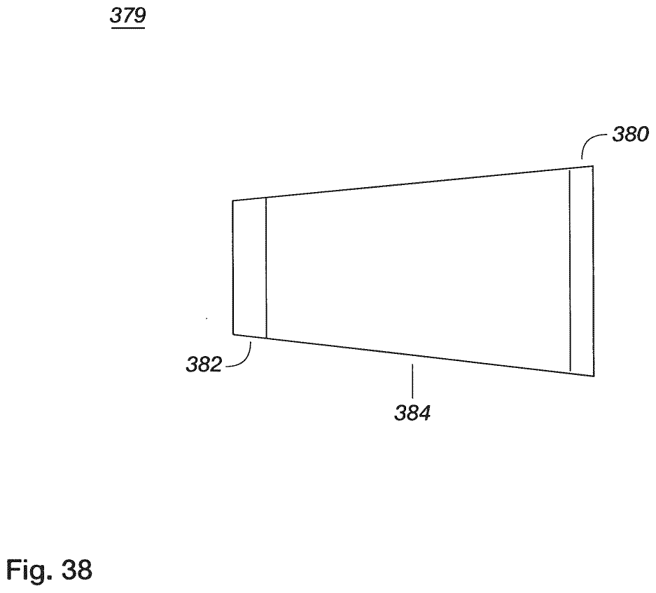

FIG. 38 is a schematic illustration that shows a generic telescope 174 or 378 with a one quarter wave plate 380, an optical fiber connector 382, and one or more mirrors and/or lenses 384.

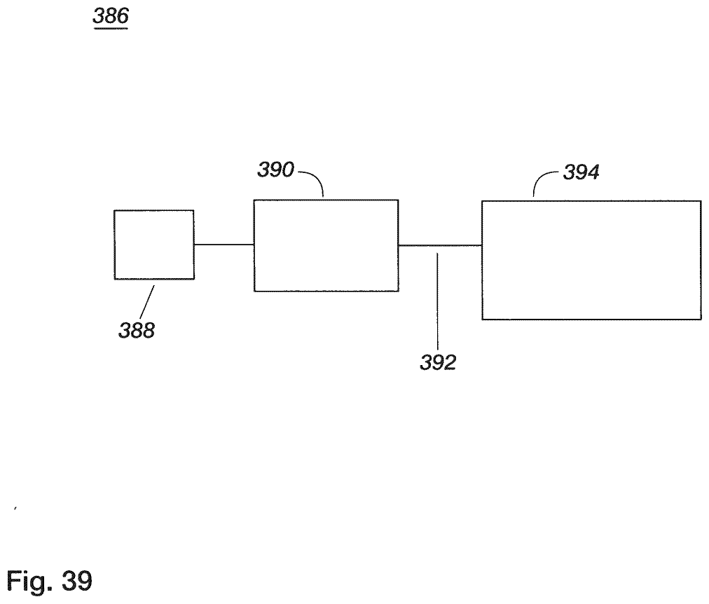

FIG. 39 is a schematic diagram that furnishes a view 386 of a Navigation Sensor connected to a Navigation Computer. A Control System 388 is shown connected to a Navigation Computer 390, which, in turn, is linked by a data path 392 to a Navigation Sensor System 394. The Navigation Computer and Control System steer the vehicle 12 and prevent collisions.

FIG. 40 is a graph 396 which shows a curve 397 which relates velocity error 398 and distance to target 400. The distance is the measurement, in meters, from the target to the telescopes 174. This graph shows the approximate behavior of velocity error as the distance to the target or range changes.

FIG. 41 is a graph 404 which shows a curve 408 that relates velocity error 398 and distance between telescopes 406. The distance is the separation in centimeters between the telescopes 174. FIG. 41 exhibits the approximate behavior of the velocity error as the distance between the telescopes changes. FIG. 41 shows the functional relationship, and the benefit, of having telescopes which are optimally separated.

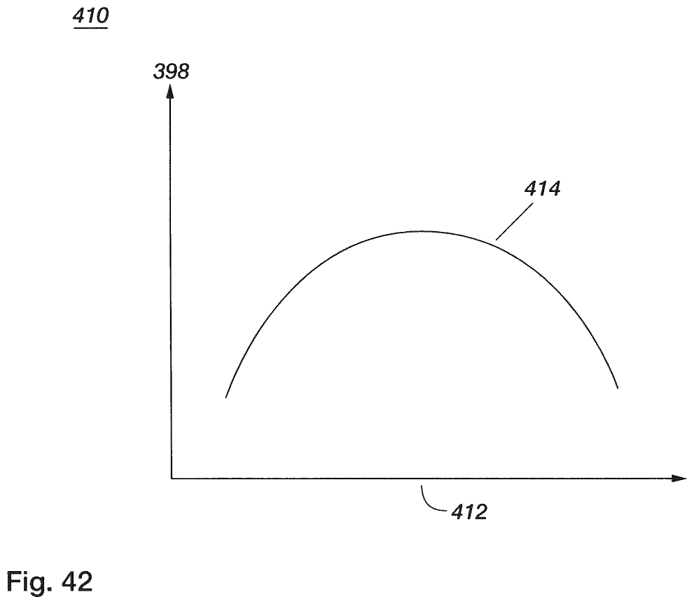

FIG. 42 is a graph 410 which shows a curve 414 that relates velocity error 398 and the angle 412 between the direction of travel of the target and the direction of travel of the sensor. FIG. 42 portrays the approximate behavior of velocity error 398 as the direction of travel of the target changes. The velocity error peaks when the target is traveling perpendicular to the beams, not coming toward the sensors or going away from the telescopes. The range of the angle shown in this graph is roughly forty-five degrees to one hundred thirty five degrees with the peak error at ninety degrees.

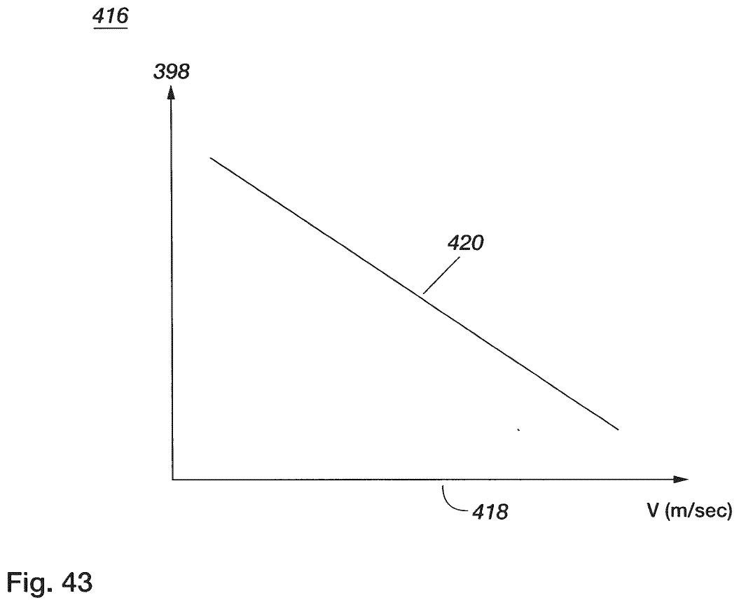

FIG. 43 is a graph which shows a curve 430 that relates the velocity error 398 and the speed of the target 418. FIG. 43 depicts the approximate behavior of velocity error 398 as the speed of the target changes. For higher speeds, the error decreases.

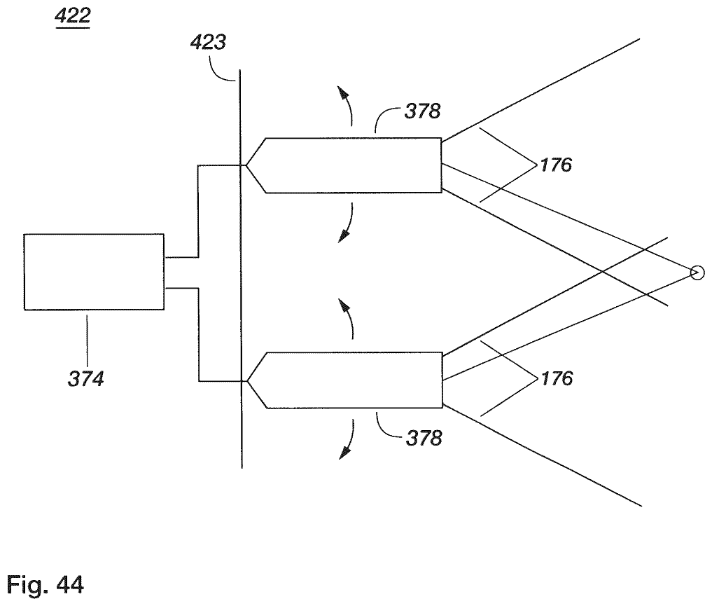

FIG. 44 is a schematic illustration 422 of one portion of one embodiment of the present invention. The Core Unit 374 is connected to two telescopes 174, which each emit beams 176 toward a target. Two steerable beams are used to find the arbitrary velocity vector for a target.

The Measurement Reference is the point, line or plane of reference for the measurements to the target. It is defined by the optical axes of the telescopes and the distance between them.

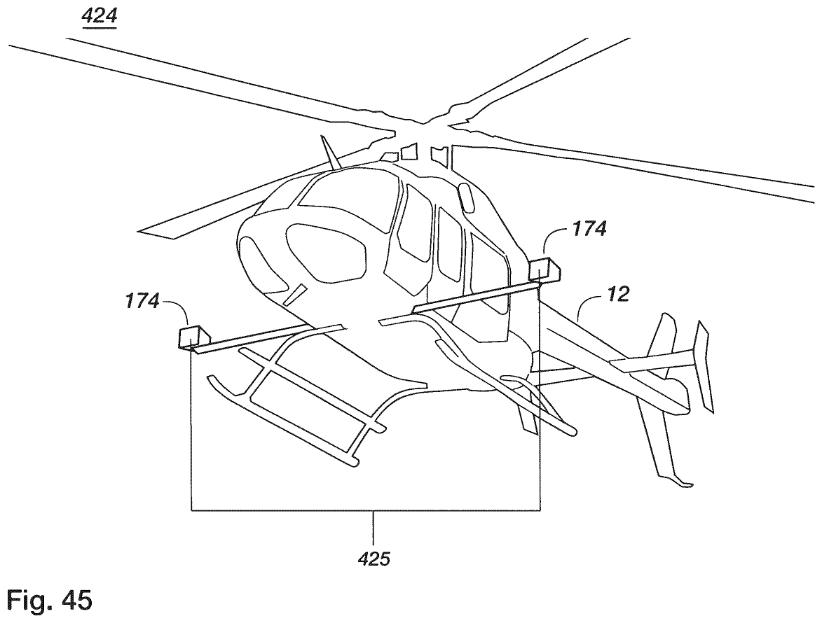

FIG. 45 is a view 424 of a helicopter 12 that is equipped with one embodiment of the present invention. The helicopter 12 includes a telescopic boom 425 that supports the telescopes 174. The width of the boom 425 is variable, which allows the telescopes to be separated by an optimal distance 176 based on the navigation and location requirements established by the pilot of the helicopter 12.

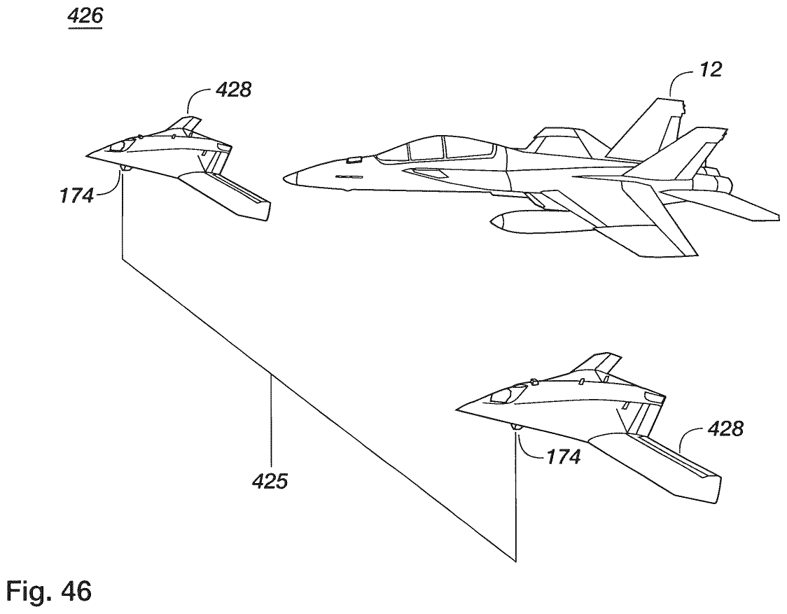

FIG. 46 is a view 426 which shows another way to vary the distance between telescopes 174. A jet aircraft is accompanied by two drones 428 which are equipped with telescopes 174. This configuration allows for a relatively large separation distance of the telescopes 425.

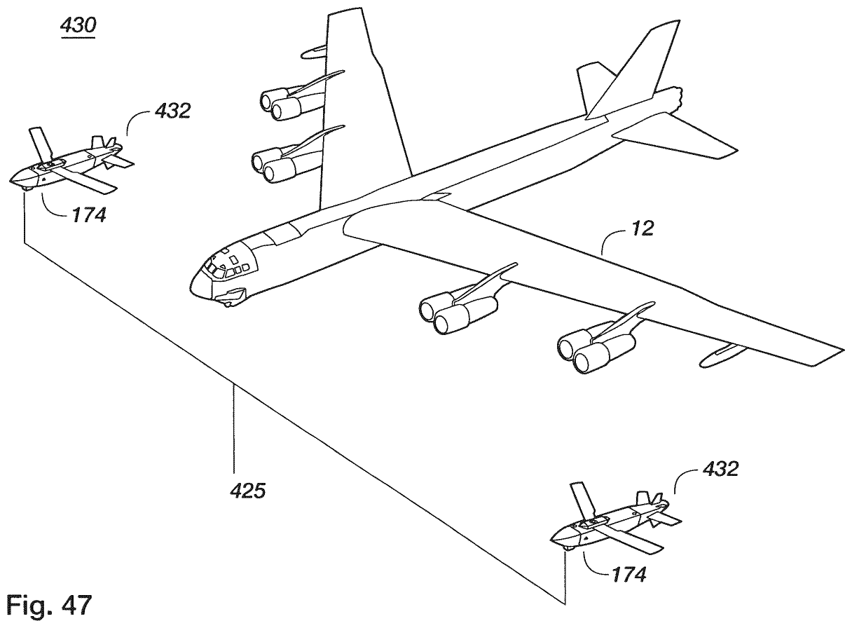

FIG. 47 is another view 430 that illustrates the method of optimizing the separation of the telescopes 174. A vehicle 12 is accompanied by two companion aircraft 432, which may be manned or unmanned. Each of the companion aircraft 432 is equipped with a telescope 174. The telescopes 174 are separated by a relatively large separation distance 425.

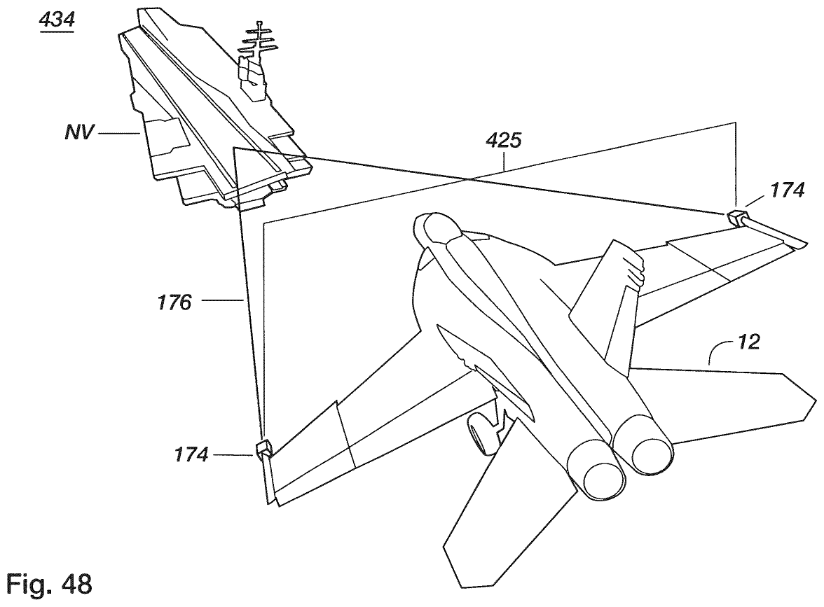

FIG. 48 is a view 434 of an aircraft 12 approaching a naval vehicle NV. The aircraft 12 is equipped with one embodiment of the present invention, and has two telescopes 174 mounted on each wing tip. The separation distance 425 is relatively large. FIG. 48 shows the use of two beams to determine relative velocity of aircraft with respect to the ship.

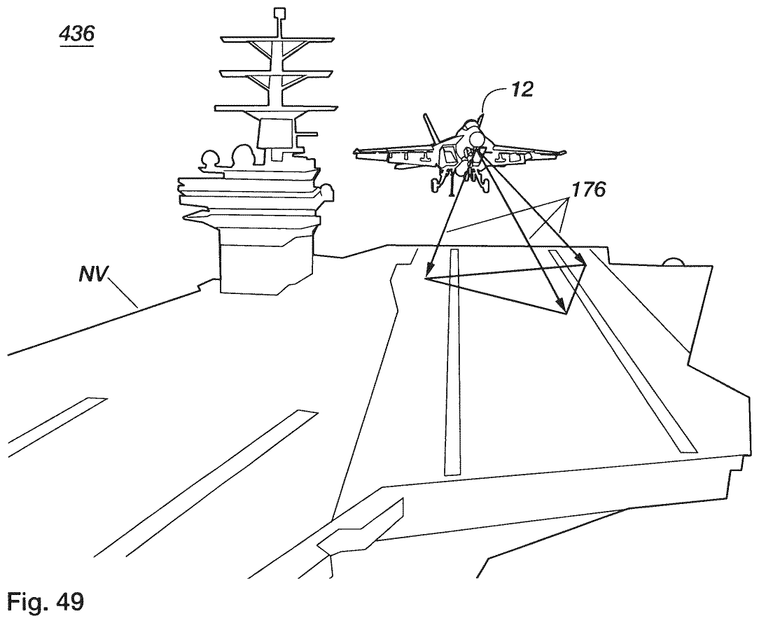

FIG. 49 is another view 436 of the ship NV just before the aircraft 12 lands on the deck. Three beams 176 are used to calculate a 3-D vector as well as attitude.

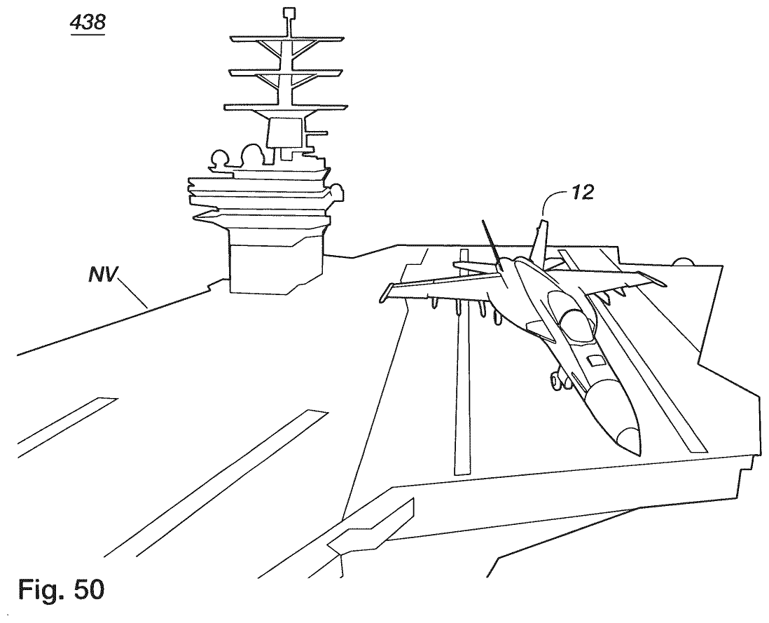

FIG. 50 is another view of the aircraft carrier NV, shown at a time after the aircraft 12 has landed safely on the deck.

### VII. Doppler LIDAR Principals of Operation: The Laser Waveform

Central to the Doppler LIDAR sensor 44 & 46 is a constant amplitude master oscillator laser 48, 64 & 138 with an applied linear frequency modulated (LFM) waveform 50, 66 & 140. As in conventional radar, continuous wave (CW) LIDAR is very good for making Doppler measurements but is fundamentally incapable of measuring range unless the waveform is modulated in some fashion. To keep CW operation, the Doppler LIDAR sensor uses frequency modulation for this purpose. Thus, the primary purpose of the LFM waveform is to obtain range measurements in addition to Doppler measurements.

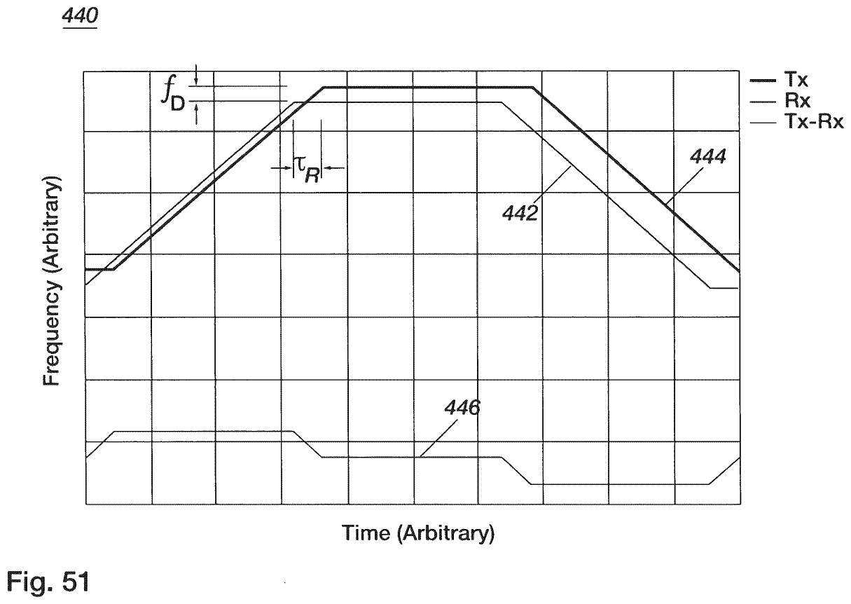

FIG. 51 is a set of graphs 440 depicting the frequency content of the transmitted and associated received waveform as a function of time. The transmitted waveform 442 consists of a linearly increasing frequency having a slope of B/T, where B is the total waveform bandwidth, and T is the duration of the ramp. In one embodiment, it is then held constant for the same duration T, and finally it is linearly decreased in frequency again for the same duration T at a slope of −B/T. The received signals 444 are delayed in time due to the round-trip time of flight of light to and from the target and shifted in frequency up or down in proportion to the target velocity by the Doppler effect. A fraction of the transmitted light serves as the reference local oscillator (LO) 54, 70 & 156, and this light is mixed with the incoming light from the target at the receiver detector 58, 74 & 150.

The resulting photo-current at the output of the detector oscillates at the difference between the transmitted and received optical frequencies. These signal frequencies 446, f_{d}, f_{R+}, f_{R-}, illustrated as a function of time in FIG. 51, are digitized and processed to obtain the desired distance and velocity measurements 42, 79 & 152.

The range is independent of the Doppler shift. The non-modulated portion of the waveform serves to provide a second independent measurement of the Doppler frequency which is generated directly from the relative motion of the sensor and target. The relative (or radial) velocity vᵣ of the target with respect to a sensor of transmitter laser wavelength λ, obeys the relationship

$${v}_{r} = \frac{λ}{2 cos θ} {f}_{d} \qquad Equation One$$

where the angle θ is the total angle between the sensor line of sight and the velocity vector.

The measured Doppler frequency has a finite spectral width which ultimately determines the measurement accuracy and can be expressed by

$$Δ {f}_{d} = - \frac{2 {v}_{r}}{λ} sin ( y ) Δ y \qquad Equation Two$$

where Δf_{d} is the half power spectrum width, and Δγ is the width of the beam in the γ direction. Equation 2 may be used to compute the improvement to accuracy that is provided by using Doppler measurements with shorter wavelengths. Consider radar Ka band used by the terminal descent sensor (TDS) in the Mars Science Laboratory mission which operated at a center wavelength of 8.39 mm and had a beam width of approximately three degrees. Comparing the Ka band to the laser-based LIDAR operating at a wavelength of 1.55E-6 m and a beam divergence of less than 3E-3 degrees (from these values alone), one can estimate an accuracy improvement of more than three orders of magnitude by using laser light rather than microwaves.

The relative range, R, and the radial velocity from Equation One between the Doppler LIDAR based sensor 44 & 46 and the target 22 & 20 is obtained by identifying three signal frequencies 446: f_{d}, f_{R+}, f_{R-} which are separable in time. The Doppler LIDAR sensor measures these three frequencies along the line of sight (LOS) of each of its telescopes.

For the special case when multiple independent LOS speed measurements are available simultaneously, a relative velocity vector is determined. In two dimensions, two independent LOS measurements are needed, in three dimensions, three LOS measurements are needed. This velocity vector provides complete knowledge of the relative speed and direction of motion between the sensor and the target.

From the sensor reference frame the target is moving at a velocity having

magnitude, |\vec{V}|, and a direction, \vec{V}=vₓ\hat{x}+v_{y}ŷ+v_{z}\hat{z}, then the measured LOS (radial) velocities of that target are M_{A}′, M_{B}′, and M_{C}, for channels A, B, and C respectively, and are obtained from the dot-products of the Doppler LIDAR sensor beam-pointing unit vectors and the velocity vector:

$$[ \begin{matrix}{M}_{A} \\ {M}_{B} \\ {M}_{C}\end{matrix} ] = [ S ] [ \begin{matrix}{v}_{x} \\ {v}_{y} \\ {v}_{z}\end{matrix} ] \qquad Equation Three$$

Equation Three provides three equations that include the measured LOS velocities as well as the three unknown velocity components vₓ, v_{y}, and v_{z}, that describe the velocity vector of interest, and can therefore be solved simultaneously to high accuracy.

Likewise, for the special case where multiple independent LOS distance measurements are available simultaneously and the target is a planar surface like the ground or a landing pad 22, the geometry reduces in such a way that the measured altitude is not a function of attitude (and thus, attitude uncertainty), and surface relative attitude can be estimated.

### Altitude Measurement Computations

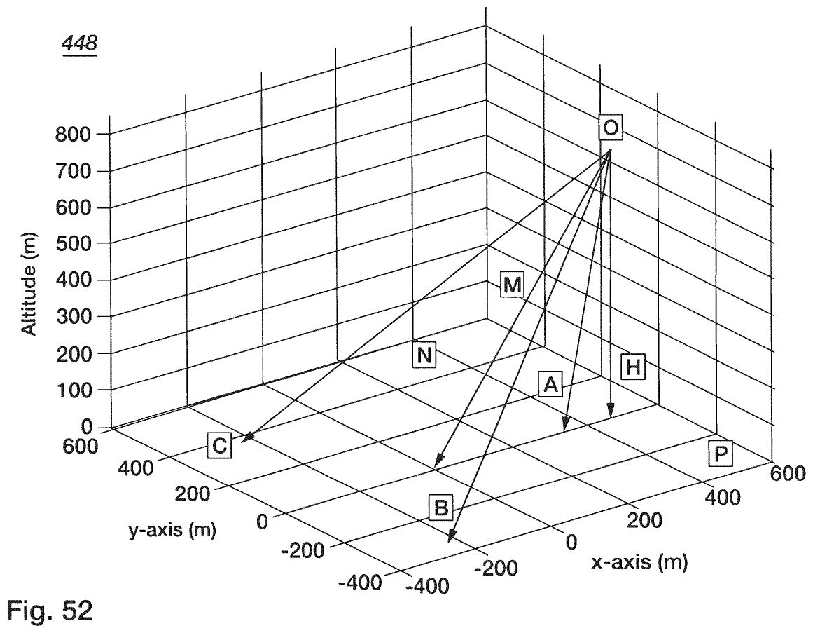

Computation of vehicle height above the ground level (AGL) is a straight forward exercise in vector analysis. FIG. 52 is a vector representation of the geometry of three beams in a typical Navigation Reference Sensor 44 operating above a planar surface 22, P. In this figure, the attitude of the sensor reference frame relative to the ground reference frame is arbitrary. Vectors OA, OB, and OC are known vectors corresponding to three transmitted beams designated as channels A, B, and C, respectively, of magnitude equal to the measured range by each beam and direction defined by the sensor's beam director design. O is a point corresponding to the origin of the sensor reference frame 25 and vectors AB, BC and CA form the ground plane P 22. The magnitude and direction of these vectors are obtained from the known vectors OA, OB, and OC:

$$AB = OB - OA \qquad Equation Four$$

$$BC = OC - OB$$

$$CA = OA - OC$$

N is defined as the normal unit vector of the plane P given by the cross-product of any two vectors in P:

$$N = \frac{BC \times AB}{\vert N \vert} \qquad Equation Five$$

M is defined as a median vector originating at O and parallel to the sensor reference frame z-axis. The magnitude of M is R_{M}. Vector M is defined as

$$M = {R}_{M} \cdot [ \begin{matrix}0 \\ 0 \\ - 1\end{matrix} ] \cdot [ \begin{matrix}\hat{x} \\ \hat{y} \\ \hat{z}\end{matrix} ] = - {R}_{M} \hat{z} \qquad Equation Six$$

The median vector amplitude R_{M} is found by noting that the vector difference (M-OA) is a vector which lies on the ground plane P, and therefore can be solved from:

$$N \cdot ( M - OA ) = N \cdot ( - {R}_{M} \hat{z} - OA ) = 0 \qquad Equation Seven$$

Once R_{M} is known, and recognizing that the altitude H is parallel to N, the vehicle height above the plane P is calculated from

$$H = {R}_{M} \cdot ( \frac{N \cdot M}{\vert N \vert \cdot \vert M \vert} ) \qquad Equation Eight$$

This computation of height does not require any additional information from other sensors (including IMUs). If all three beams intersect the ground plane, the altitude measurement is the shortest distance to the ground plane. In contrast, when measuring height using a laser range-finder, the altitude is obtained by the range measurement and the vehicle's attitude as measured by an Inertial Measurement Unit.

### Ground Plane Relative Attitude

Given the geometry of the telescope pointing within the sensor's reference frame as shown in FIG. 52, the ground reference plane is known according to its normal unit vector N, the attitude of the sensor's reference frame relative to that ground reference plane can be obtained. Vehicle attitude refers to roll (α) FIG. 53, which is rotation of the vehicle along the x-axis, pitch (B) FIG. 54, rotation along the y-axis and yaw(γ) FIG. 55, rotation along the z-axis. Description of the sensor reference frame can be made using one of the 24 angle set conventions that best simplifies the solutions to roll, pitch, and yaw for this system.

The computation of the heading relative to the direction of motion can be obtained after applying the roll and pitch rotation to the velocity vector. After correction in roll and pitch, side slip angle (SSA) is given by

$$SSA = {tan}^{- 1} ( \frac{{V}_{y}}{{V}_{x}} ) \qquad Equation Nine$$

Where Vₓ and V_{Y} correspond to the rotated components of the velocity vector. For the assumption that the platform and sensor x-axes are identical, a similar parameter can be given for angle of approach (AoA) which is defined as the angle made by the x-axis of the platform and the direction of travel:

$$AoA = {tan}^{- 1} ( \frac{{V}_{y}}{{V}_{x}} ) \qquad Equation Ten$$

FIGS. 53, 54, and 55 illustrate roll, pitch, and yaw for any vehicle. In FIGS. 53 and 54, the down vector is the gravity vector, the other two simply indicate plus and minus roll and pitch. In FIG. 55, the vector to the right is the direction of travel and the other two, pointed at by the yaw arrows represent plus or minus yaw. The direction of plus or minus is arbitrary.

### Scope of the Claims

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Navigation System for GPS Denied Environments have been disclosed above are intended to educate the reader about preferred embodiments of the invention, and are not intended to constrain the limits of the invention or the scope of the Claims.

### LIST OF REFERENCE CHARACTERS

A Automobile
B Bicyclist
D Drone
E Enemy troops
H Helicopter
HZ Hostile zone
LS Landing site
NV Naval vessel
MB Military base
MR Mountain range
P Pedestrian
S Satellite
SCA Small civilian aircraft
WM Windmill
10 Navigation System in a GPS Denied Environment
12 Vehicle
14 Portion of ground
16 Flight path
18 Generalized sensor system reference frame: three dimensions
20 Target
22 Universal reference frame
24 Vehicle reference frame in three dimensions
26 Target reference frame in three dimensions
27 Generalized sensor system reference frame: two dimensions
28 Vehicle reference frame in two dimensions
30 Target reference frame in two dimensions
32 Schematic diagram of a generalize vehicle
34 Location Processor
36 Heading Sensor
38 Absolute Location Sensor
40 Timer
42 Range Doppler Processor
44 Navigation Reference Sensor
46 Area Range and Velocity Sensor
48 Narrow Linewidth Emitter
50 Waveform Generator
52 Transmitter
54 Local Oscillator
56 Transmit/Receive Boresight
58 Receiver
60 Static Beam Director
62 Beams from Static Beam Director
64 Narrow Linewidth Emitter
66 Waveform Generator
68 Transmitter
70 Local Oscillator
72 Transmit/Receive Boresight
74 Receiver
76 Dynamic Beam Director
78 Beams from Dynamic Beam Director
79 Flow chart for Range Doppler Processor
82 Demodulate receiver output
84 Determine spectral content
86 Discriminate signal frequencies from noise
88 Obtain velocity from signal frequency
90 Obtain distance from signal frequency
92 Convert range and velocity frequencies to engineering units
94 Send data to Location Processor
96 Flow chart for Location Processor
98 Obtain range and velocity of universal reference frame
100 Obtain attitude and heading of universal reference frame relative to sensor frame
102 Apply translation/rotation transformation of sensor case frame to vehicle frame (center of gravity)
104 Apply translation/rotation transformation of vehicle frame relative to universal reference frame
106 Obtain range and velocity of target in vehicle reference frame
108 Obtain attitude and heading of a target relative to vehicle reference frame
110 Apply translation/rotation transformation of sensor case frame to vehicle frame (center of gravity)
112 Apply translation/rotation transformation of target relative to universal reference frame
114 Pilot/navigator displays
116 Surface relative velocity: Vx
118 Surface relative velocity: Vy
119 Surface relative velocity: Vz
120 Surface relative altitude
122 Flight path angle
124 Velocity
126 Angle of attack
128 Surface relative pitch angle
130 Navigation attributes
132 Side-slip angle
134 Surface relative roll angle
136 Coherent LIDAR Method
138 Narrow linewidth emitter
140 Waveform generator produces modulated emitter output
142 Modulated emitter output divided into two paths
144 Transmitter waveform is amplified
146 Local oscillator waveform is relayed to receiver
148 Waveform transmitted to target and return beam is received by the beam director
150 Received signals are mixed with local oscillator
152 Signals are processed to obtain distance and velocity
154 Data provided to location processor
156 Algorithm to determine current location
158 Obtain current position from internal or external sources
160 Start clock and movement of vehicle
162 Determine heading
164 NRS measures vehicle velocity
166 ARVS measures range and relative speed of objects
168 Calculate new position of vehicle
170 Calculate new position of other objects
172 Send data to GN&C computer
174 Pair of optimally separated telescopes on vehicle
175 Distance between telescopes
176 Dynamically steered beams from pair of telescopes on vehicle
178 Schematic diagram of apparatus for producing separated dynamically pointed beams
180 Dynamic Area Range and Velocity Sensor
182 Core Doppler LIDAR Unit
184 Dynamic Beam Directors
186 Schematic diagram
188 Beam from First Dynamic Beam Director
190 Beam from First Dynamic Beam Director
192 Beam from Second Dynamic Beam Director
194 Beam from Second Dynamic Beam Director
196 Flow chart
198 Begin area surveillance
200 Dual beam independent area scan
202 Determine if current time is greater than Δt for an identified moving target
204 Determine if target is found
206 Measure Range 1 & radial velocity
208 Obtain pointing angles α1 and β1
210 Compare radial velocity 1 to reference sensor/vehicle trajectory
212 Calculate target position and registration of beam 2
214 Measure range 2
216 Measure radial velocity 2
218 Obtain pointing angels
220 Calculate target trajectory
222 Determine if target is moving
224 Place/verify target identifier
226 Record projected position at time At
228 Position beam 1 on previously identified moving target using past trajectory estimate
230 Determine if target has been found
232 Schematic diagram
234 Waveform generator
236 Laser
237 Amplifier
238 Modulator
240 Filter
242 Output
244 Schematic diagram
246 Input from local oscillator
248 Waveguide switches
250 Switch
252 Switch
254 Switch
256 Switch
258 Optical Waveguide
260 Diode
264 Output to amplifier
266 Anti-aliasing filter
268 A to D converter
270 Diode
272 Optical Waveguide
274 Diode
276 Diode
278 Anti-aliasing filter
280 Output to amplifier
282 A to D converter
284 Optical Waveguide
290 Output to amplifier
292 Anti-aliasing filter
294 A to D converter
296 Optical Waveguide
298 Diode
300 Diode
302 Output to amplifier
304 Anti-aliasing filter
306 A to D converter
308 Schematic diagram
312 Local oscillator
314 Photodetector
316 A to D converter
318 Field programmable gate array
319 Multiple channels
320 Local oscillator
322 Inputs to photodetectors
324 Photodetector
326 A to D converter
327A A to D converter
327B A to D converter
330 Filter
332 Post processing circuit
334 Photodetector
336 Photodetector
338 FFT chip
340 Filter
342 Post processing circuit
344 Photodetector
348 FFT chip
350 Filter
352 Post processing circuit
356 A to D converter
358 FFT chip
362 Post processing circuit
364 Scene depicted in FIG. 32A
366 Second view of scene depicted in FIG. 32A
368 Overhead view
369 View of car with sensors
370 Overhead view
372 Navigation Sensor System
374 Core Unit
376 Optical fiber
378 Amplifier
380 One quarter wave plate
382 Detector
385 Transceiver
384 Mirror or lens
386 Navigation Sensor connected to Navigation Computer
388 Control System
390 Navigation Computer
392 Data path
394 Navigation Sensor System
396 Graph
397 Curve
398 Velocity error
400 Curve
402 Distance to target
404 Graph
406 Telescopes
408 Curve
410 Graph
412 Angle
414 Curve
416 Graph
418 Target
422 Schematic
424 View of Helicopter
425 Telescopic boom
426 View of varying distance between telescopes
428 Drones
430 Curve
431 View illustrating method of optimizing separation of telescopes
432 Companion aircraft
434 Aircraft approaching naval vehicle
436 Second view of aircraft approaching naval vehicle
438 View of aircraft after landing on deck of naval vehicle
440 Graphs
442 Transmitted waveform
444 Received signals
446 Signal frequencies
448 Graph of altitude versus distances
450 Front view of roll
452 Side view of pitch
454 Top view of yaw

What is claimed is:

1. A system for determining a relative surface velocity vector, comprising:
a narrow linewidth emitter to provide a coherent electromagnetic signal comprising a linewidth of less than 100 kHz;
a transmitter to transmit the emitter output via a boresight component as an optical transmitted signal, the boresight component configured to transmit the optical transmitted signal and receive reflected optical signal;
a receiver coupled to the boresight component to receive the reflected optical signal and produce an electrical output based on the reflected optical signal;
an oscillator to generate an oscillated signal to be combined with the electrical output to produce a signal that is amplified according to a bandwidth of the oscillated signal; and
a processor to determine, based on the linewidth and the signal, a velocity vector of the system, the velocity vector comprising a magnitude of velocity and a direction of travel of the system along a line of sight of the boresight component relative to the system.

2. The system of claim 1, wherein the narrow linewidth emitter is further configured to provide a linewidth of no greater than 10 kHz.

3. The system of claim 1, further comprising a waveform generator, coupled with the narrow linewidth emitter, to generate the emitter output that is modulated based on the coherent electromagnetic signal, wherein the waveform generator is further configured to implement a linear frequency modulation on the coherent electromagnetic signal to determine a range using frequency domain.

4. The system of claim 1, wherein the receiver is further configured to mix the reflected optical signal with a local oscillator in a homodyne or heterodyne configuration.

5. The system of claim 1, wherein the processor is further configured to determine velocity from a Doppler frequency and distance from modulation sidebands in a frequency-domain analysis of the signal that is demodulated using the oscillated signal.

6. The system of claim 1, wherein the processor is further configured to apply translation and rotation transformations between a sensor frame, a vehicle frame, and a universal reference frame to express the velocity vector in a selected frame.

7. The system of claim 1, wherein the processor is configured to store the signal and corresponding velocity vector data over time in a memory, and to output a trajectory of the system based on sequential velocity vector determinations along the line of sight of the boresight component.

8. A method for determining a relative surface velocity vector, the method comprising:
providing, by a narrow linewidth emitter, a coherent electromagnetic signal having a linewidth of less than 100 kHz;
transmitting the emitter output as an optical transmitted signal via a boresight component, the boresight component being configured to transmit the optical transmitted signal and receive a reflected optical signal;
receiving, by a receiver coupled to the boresight component, the reflected optical signal and producing an electrical output based on the reflected optical signal;
combining the electrical output with an oscillated signal generated by an oscillator to produce a signal that is amplified according to a bandwidth of the oscillated signal; and
determining, by a processor and based on the linewidth and the signal, a velocity vector, the velocity vector comprising a magnitude of velocity and a direction of travel along a line of sight of the boresight component.

9. The method of claim 8, wherein providing the coherent electromagnetic signal comprises providing a signal having a linewidth of no greater than 10 kHz.

10. The method of claim 8, further comprising:
generating, by a waveform generator coupled to the narrow linewidth emitter, a modulated emitter output based on the coherent electromagnetic signal; and
implementing, by the waveform generator, a linear frequency modulation on the coherent electromagnetic signal to enable determination of range in a frequency domain.

11. The method of claim 8, wherein receiving the reflected optical signal further comprises mixing the reflected optical signal with a local oscillator in a homodyne or heterodyne configuration.

12. The method of claim 8, further comprising determining a velocity from a Doppler frequency and determining a distance from modulation sidebands in a frequency-domain analysis of the signal that is demodulated using the oscillated signal.

13. The method of claim 8, further comprising applying, by the processor, translation and rotation transformations between a sensor frame, a vehicle frame, and a universal reference frame to express the velocity vector in a selected frame.

14. The method of claim 8, further comprising:
storing, by the processor, in a memory, the signal and velocity vector determinations over time; and
outputting a trajectory based on sequential velocity vector determinations along the line of sight of the boresight component.

15. A device for determination of a relative surface velocity vector, the device comprising:
a coherent light source having a linewidth less than 100 kHz;
a modulation generator coupled to the light source and configured to apply a modulation to produce a modulated optical signal;
a boresight optical path configured to direct the modulated optical signal toward a surface and to collect a reflected optical signal;
a detection module configured to generate an electrical output from the reflected optical signal;
an oscillator configured to provide an oscillated reference signal;
a demodulation circuit configured to mix the electrical output with the oscillated reference signal to obtain a demodulated signal and to amplify the demodulated signal according to a bandwidth of the oscillated reference signal; and
a processing unit configured to compute, from the linewidth and the demodulated signal, a velocity vector including a speed magnitude and a direction of travel along a line of sight of the boresight optical path relative to the device.

16. The device of claim 15, wherein the coherent light source is further configured to provide a linewidth of no greater than 10 KHz.

17. The device of claim 15, wherein the modulation generator is configured to implement a linear frequency modulation on the coherent light to determine a range in a frequency domain.

18. The device of claim 15, wherein the detection module is configured to mix the reflected optical signal with the oscillated reference signal in a homodyne or heterodyne configuration.

19. The device of claim 15, wherein the processing unit is configured to determine a velocity from a Doppler frequency and a distance from modulation sidebands in a frequency-domain analysis of the demodulated signal.

20. The device of claim 15, wherein the processing unit is further configured to apply translation and rotation transformations between a sensor frame, a device frame, and a universal reference frame to express the velocity vector in a selected frame.
